(19) United States
(12) Patent Application Publication
(10) Pub. No.: US 2026/0310717 A1
(43) Pub. Date: Oct. 8, 2026

(54) Autonomous Visual Information Seeking with Machine-learned Language Models

(71) Applicant: Google LLC, Mountain View, CA (US)

(72) Inventors: Ahmet Iscen, Grenoble (FR); Alireza Fathi, Mountain View, CA (US); Ziniu Hu, Los Angeles, CA (US); David Alexander Ross, San Jose, CA (US); Cordelia Luise Schmid, Saint-Ismier (FR); Chen Sun, San Francisco, CA (US)

(21) Appl. No.: 19/477,700

(22) PCT Filed: Jun. 4, 2024
(86) PCT No.: PCT/US2024/032378

§ 371 Date: Oct. 22, 2025

Related U.S. Application Data
(60) Provisional application No. 63/506,924, filed on Jun. 8, 2023.

(51) Int. Cl. G06F 16/435

(52) U.S. Cl. CPC G06F 16/435

(57) ABSTRACT

Systems and methods for generating a response to a visual information query can include obtaining input data, processing the input data with one or more machine-learned models, transmitting data to one or more data processing tools, and generating a response based on the input data and the one or more outputs of the one or more data processing tools. The one or more machine-learned models may iteratively process data to generate planning data that may include application programming interface calls to the one or more data processing tools. The one or more machine-learned models may be utilized for planning, reasoning, and response generation when obtaining and generating a response to a visual information query.

### RELATED APPLICATIONS

The present application is based on and claims priority to U.S. Provisional Application No. 63/506,924 having a filing date of Jun. 8, 2023. Applicant claims priority to and the benefit of each of such application and incorporate all such application herein by reference in its entirety.

### FIELD

The present disclosure relates generally to autonomous visual information seeking with machine-learned language models. More particularly, the present disclosure relates to leveraging one or more machine-learned language models for planning data processing calls and information reasoning to generate a response to a visual information query.

### BACKGROUND

Large language models can display impressive language understanding and predictive capabilities. However, large language models may struggle with fact specific queries. Additionally, language models may not be trained for non-text based and/or non-embedding based data. For example, language models may be unable to properly process visual information queries associated with one or more images.

Additionally, understanding the world at large can be difficult. Whether an individual is trying to understand what the object in front of them is, trying to determine where else the object can be found, and/or trying to determine where an image on the internet was captured from, text searching alone can be difficult. In particular, users may struggle to determine which words to use. Additionally, the words may not be descriptive enough and/or abundant enough to generate desired results.

### SUMMARY

Aspects and advantages of embodiments of the present disclosure will be set forth in part in the following description, or can be learned from the description, or can be learned through practice of the embodiments.

One example aspect of the present disclosure is directed to a computing system for visual information seeking. The system can include one or more processors and one or more non-transitory computer-readable media that collectively store instructions that, when executed by the one or more processors, cause the computing system to perform operations. The operations can include obtaining input data. The input data can include image data and text data. The text data can include a query associated with the image data. The operations can include processing the input data with a machine-learned model to generate first planning data. The first planning data can be descriptive of instructions to provide the input data to a first data processing tool. The operations can include transmitting, based on the first planning data, the input data to the first data processing tool to retrieve first output data. The operations can include processing the input data and the first output data with the machine-learned model to generate second planning data. The second planning data can be descriptive of instructions to transmit data to a second data processing tool. The operations can include transmitting, based on the second planning data, data to the second data processing tool to retrieve second output data and processing the input data and the second output data with the machine-learned model to generate response data. The response data can be descriptive of a response to the query.

In some implementations, the first data processing tool can include an object detection model. The first output data can include one or more bounding boxes associated with one or more objects in the image data. The first output data can include one or more segmented portions of one or more images of the image data and caption data associated with the one or more segmented portions. The caption data can be descriptive of an object classification associated with one or more objects detected in the one or more segmented portions of one or more images.

In some implementations, the second data processing tool can include a search engine. The second planning data can include a model-generated query. The model-generated query can be transmitted to the second data processing tool to retrieve the second output data. The model-generated query can be generated based on the input data and the first output data. The model-generated query can be descriptive of the query of the input data modified based on the first output data. In some implementations, the response data can include a natural language text string that is responsive to the query of the input data.

In some implementations, the operations can include processing the input data and the second output data with the machine-learned model to generate third planning data. The third planning data can be descriptive of instructions to transmit data to a third data processing tool. The operations can include transmitting, based on the third planning data, data to the third data processing tool to retrieve third output data and processing the input data and the third output data with the machine-learned model to generate the response data.

Another example aspect of the present disclosure is directed to a computer-implemented method for responding to visual prompts. The method can include obtaining, by a computing system including one or more processors, input data. The input data can include image data and text data. In some implementations, the text data can include a query associated with the image data. The method can include processing, by the computing system, the input data with a machine-learned model to generate first planning data. The first planning data can be descriptive of instructions to provide the image data to a first data processing tool. The method can include providing, by the computing system, the image data to the first data processing tool to receive first output data. The first output data can be generated with the first data processing tool based on the image data. The method can include processing, by the computing system, the first output data with the machine-learned model to generate second planning data. In some implementations, the second planning data can be descriptive of instructions to provide a particular portion of the image data to a second data processing tool. The method can include providing, by the computing system, the particular portion of the image data to the second data processing tool to receive second output data. The second output data can be generated with the second data processing tool based on the particular portion of the image data. The method can include processing, by the computing system, the text data and the second output data with the machine-learned model to generate response data. The response data can be descriptive of a response to the query.

In some implementations, the machine-learned model may have been conditioned on a training dataset including a plurality of training examples. Each training example of the plurality of training examples can include a training input, a training output, and a training rationale. The training rationale can be descriptive of a sequence of processing instances and tool calls for determining the output data. The machine-learned model may have been conditioned on a training dataset including sequence data. In some implementations, sequence data can be descriptive of a sequence of actions for generating a training response in response to obtaining a particular type of input. The machine-learned model may have been conditioned on human input data descriptive of actions a human selected as being particular actions to perform when a particular input type is received. The human input data may have been obtained via a user interface that provides a plurality of selectable options for a user. In some implementations, the plurality of selectable options can include a plurality of external tools to call and a final output option.

Another example aspect of the present disclosure is directed to one or more non-transitory computer-readable media that collectively store instructions that, when executed by one or more computing devices, cause the one or more computing devices to perform operations. The operations can include obtaining input data. The input data can include image data and text data. In some implementations, the text data can include a query associated with the image data. The operations can include processing the input data with a machine-learned model to generate first planning data. The first planning data can be descriptive of instructions to provide the image data to a first data processing tool. The operations can include providing the image data to the first data processing tool and receiving first output data from the first data processing tool based on the image data. The operations can include processing the first output data with the machine-learned model to generate second planning data. The second planning data can be descriptive of instructions to provide a particular portion of the image data to a second data processing tool. The operations can include providing the particular portion of the image data to the second data processing tool and receiving second output data from the second data processing tool based on the particular portion of the image data. The operations can include processing the text data and the second output data with the machine-learned model to generate response data. The response data can be descriptive of a response to the query.

In some implementations, the query can be descriptive of a question associated with a particular object depicted in the image data. The first data processing tool can detect a plurality of objects depicted in the image data, generate a plurality of bounding boxes associated with the plurality of objects, generate a plurality of image segments based on the plurality of bounding boxes, classify each of the plurality of objects in the plurality of image segments to generate a plurality of object classifications, and generate the first output data. The first output data can include the plurality of image segments and the plurality of object classifications. In some implementations, the second data processing tool can include an image search engine. The second data processing tool can process one or more of the plurality of image segments with the image search engine to determine one or more web resources associated with the one or more of the plurality of image segments. The one or more of the plurality of image segments can be selected by the machine-learned model based on the input data and the plurality of object classifications. The second data processing tool can generate the second output data based on the one or more web resources.

Another example aspect of the present disclosure is directed to a computing system. The system can include one or more processors and one or more non-transitory computer-readable media that collectively store instructions that, when executed by the one or more processors, cause the computing system to perform operations. The operations can include obtaining input data. The input data can include image data and text data. The text data can include a query associated with the image data. The operations can include processing the input data with an artificial intelligence system to generate response data. The response data can be descriptive of a response to the query. The artificial intelligence system can include a language model planner block, a language model reasoner block, and a working memory. In some implementations, the language model planner block may have been conditioned to determine one or more data processing tools to utilize for processing data associated with responding to the query. The language model reasoner block may have been conditioned to process outputs of the one or more data processing tools to determine information associated with responding to the query. The working memory can store acquired information obtained and generated with the artificial intelligence system. The operations can include providing the response data as an output.

In some implementations, the artificial intelligence system can include one or more machine-learned models conditioned on user behavior data. The user behavior data can be processed to generate a transition graph that is descriptive of a determined sequence of decisions made by users when performing a particular information seeking task. The transition graph can be descriptive of a plurality of distinct states and can indicate a particular set of actions available at each state of the plurality of distinct states. The user behavior data may have been utilized to condition the language model planner block and the language model reasoner block for particular context-based processing.

In some implementations, the one or more data processing tools can include at least one of a computer vision tool, a web search tool, or an image search tool. The computer vision tool can include at least one of an object detection model, an optical character recognition model, an image captioning model, or a visual question-and-answer model. The web search tool can retrieve open world knowledge from web resources. The image search tool can identify relevant information from metadata associated with visually similar images. In some implementations, the language model planner block may have been conditioned to generate a processing tool query to provide to the one or more data processing tools based on the input data.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1 depicts a block diagram of an example visual information determination system according to example embodiments of the present disclosure.

FIG. 2 depicts a block diagram of an example visual information seeking system according to example embodiments of the present disclosure.

FIG. 3 depicts a flow chart diagram of an example method to perform visual query processing according to example embodiments of the present disclosure.

FIG. 4A depicts a block diagram of an example automated visual information seeking system according to example embodiments of the present disclosure.

FIG. 4B depicts a block diagram of an example automated visual information seeking workflow system according to example embodiments of the present disclosure.

FIG. 5 depicts a block diagram of an example API tool call system according to example embodiments of the present disclosure.

FIG. 6 depicts an illustration of an example user data collection interface according to example embodiments of the present disclosure.

FIG. 7 depicts a flow chart diagram of an example method to perform visual query response generation according to example embodiments of the present disclosure.

FIG. 8 depicts a flow chart diagram of an example method to perform response generation according to example embodiments of the present disclosure.

FIG. 9A depicts an illustration of an example visual information determination process according to example embodiments of the present disclosure.

FIG. 9B depicts an illustration of an example visual query processing system according to example embodiments of the present disclosure.

FIG. 10 depicts a flow chart diagram of an example method to perform artificial intelligence system processing according to example embodiments of the present disclosure.

FIG. 11A depicts a block diagram of an example computing system that performs visual query processing according to example embodiments of the present disclosure.

FIG. 11B depicts a block diagram of an example computing system that performs visual query processing according to example embodiments of the present disclosure.

Reference numerals that are repeated across plural figures are intended to identify the same features in various implementations.

### DETAILED DESCRIPTION

Generally, the present disclosure is directed to systems and methods for visual information query processing and response generation. In particular, the systems and methods disclosed herein can leverage one or more machine-learned language models (e.g., a tuned and/or conditioned large language model) for planning and reasoning, which can include application programming interface tool calls. For example, input data including text data and image data can be obtained. The text data can be descriptive of a query associated with the image data (e.g., “When was this object invented?”). The input data can be processed with a machine-learned model to generate first planning data. The first planning data can include an application programming interface call to provide a first set of data (e.g., one or more images of the image data) to a first data processing tool (e.g., an object detection and captioning model). First output data (e.g., one or more segmented image patches with captions and/or classifications) can then be obtained from the first data processing tool based on the transmission of the first set of data. The first output data can then be processed with the machine-learned model to determine if a response can be generated and/or to generate second planning data to perform another data processing tool. The systems and methods can iteratively generate application programming interface calls and output data processing until a response (e.g., a response to the query) is generated.

Responding to visual questions that necessitate external knowledge, such as “What event is commemorated by the building depicted in this image?”, can be a complex task. The task can present a combinatorial search space that demands a sequence of actions, including invoking APIs, analyzing their responses, and making informed decisions. Existing language models and/or search engines alone may struggle with the task as language understanding and web resource identification separately may not provide an adequate response.

The systems and methods disclosed herein can leverage a machine-learned language model and one or more data processing tools to perform visual information seeking. In particular, the systems and methods can utilize a machine-learned language model for planning and reasoning. For example, the machine-learned language model can process input data and/or output data from a data processing tool to determine an action (e.g., a next action) for obtaining relevant information for responding to the input data. The machine-learned language model can determine application programming interface calls to request information from one or more data processing tools. The machine-learned language model can generate planning data that includes the API call and may include a model-generated query to be provided to the one or more data processing tools.

Additionally and/or alternatively, the machine-learned language model can process the outputs from the one or more data processing tools to determine the relevant information from the outputs. The machine-learned language model can then determine whether further data processing tools are to be performed before generating the response data to provide to the user.

The planning and reasoning processing can be performed iteratively until the machine-learned language model determines a response can be generated and provided. In some implementations, the systems and methods can include a working memory that stores the input data and the outputs of the one or more data processing models to track and utilize the obtained and generated data throughout the different stages of the visual information retrieval and responding process.

The systems and methods can include conditioning the machine-learned model on action example sets. The action example sets can include collected user behavior data descriptive of user selections in a user interface for how the user would perform the visual information seeking task when utilizing a plurality of data processing tools. A transition graph may be constructed and/or learned based on the collected user behavior data. The transition graph may be associated with a particular task and/or a particular group of tasks. The conditioned machine-learned model can then perform information seeking planning and reasoning.

The systems and methods of the present disclosure provide a number of technical effects and benefits. As one example, the system and methods can be utilized to leverage a machine-learned language model for tool processing planning and reasoning, which can enable the system to accurately and efficiently respond to visual information queries. In particular, a language model can be conditioned to iteratively process data to determine when and/or how to utilize one or more data processing tools (e.g., an object detection tool, an image captioning tool, a web search tool, an image search tool, etc.). Additionally and/or alternatively, the language model can be conditioned to process the outputs of the data processing tools to extract relevant information that can then be utilized to determine another API call and/or to generate the final response. In some implementations, a user interface can be utilized to collect user behavior data that can be utilized to condition the language model based on the actions performed by a set of users.

Another example technical effect and benefit relates to improved computational efficiency and improvements in the functioning of a computing system. For example, a technical benefit of the systems and methods of the present disclosure is the ability to reduce the computational resources needed for machine-learned model visual information seeking by reducing the instances of useless tool calls. In particular, the language model may process data and generate planning data one state at a time in order to mitigate the instances of a tool being utilized in a useless manner. In particular, pre-planning of data processing tool uses for an entire pipeline can lead to instances in which an output of one tool may cause the use of another tool to be needless, counterproductive, redundant, and/or illogical. The systems and methods disclosed herein can iteratively utilize the machine-learned language model to generate planning data (e.g., API calls) based on the input data, tool outputs, and/or reasoning data.

With reference now to the Figures, example embodiments of the present disclosure will be discussed in further detail.

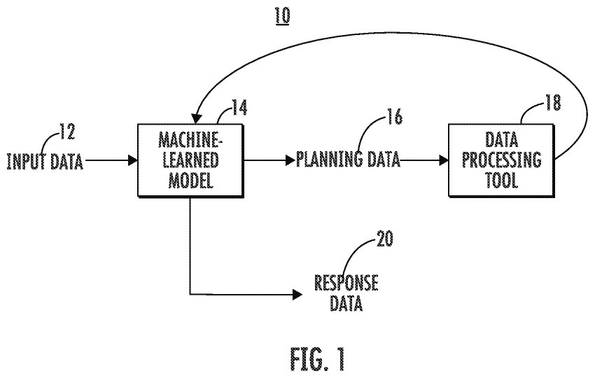

FIG. 1 depicts a block diagram of an example visual information determination system 10 according to example embodiments of the present disclosure. In some implementations, the visual information determination system 10 is configured to receive, and/or obtain, a set of input data 12 descriptive of a prompt associated with requesting information associated with one or more images and, as a result of receipt of the input data 12, generate, determine, and/or provide response data 20 that is descriptive of a response to the prompt. Thus, in some implementations, the visual information determination system 10 can include a machine-learned model 14 that is operable to plan data processing tool 18 calls and reason whether further calls are to be performed before generating a response.

In particular, the visual information determination system 10 can include obtaining input data 12. The input data 12 can include text data and image data descriptive of a prompt. The prompt may be associated with a request to receive information associated with one or more details in one or more images of the image data (e.g., “What is the origin of this building?”).

The input data 12 can be processed with a machine-learned model 14 (e.g., a large language model) to generate planning data 16. The planning data 16 can be descriptive of an action to perform. For example, the planning data 16 can include an application programming interface call to transmit data to a data processing tool 18. In some implementations, the planning data 16 can include a model-generated dataset that may be generated to provide the data processing tool 18 with a particular set of data to obtain information.

The data processing tool 18 may include an object detection model, an image classification model, an image captioning model, a segmentation model, an object classification model, a computer vision model, an optical character recognition model, an augmentation model, a generative model, a visual question answering model, a web search engine, an image search engine, and/or another tool. The data processing tool 18 may be separate from the machine-learned model 14 that generated the planning data 14.

The output of the data processing tool 18 may be obtained and processed with the machine-learned model to determine (or extract) the relevant information from the output. The output and the input data 12 can be processed with the machine-learned model 14 to determine whether another data processing tool call is to be performed. The generation of planning data 16, processing with data processing tool(s) 18 and processing of the output of the data processing tool(s) 18 may be performed until the machine-learned model 14 determines a response can be generated. If the machine-learned model 14 determines no further API calls are required to respond to the prompt, the machine-learned model 14 (e.g., a generative language model) may generate response data 20. The response data 20 may be descriptive of a response to the prompt and may include one or more natural language text strings. In some implementations, the response data may include image data, links, latent encoding data, audio data, statistical data, multimodal data, and/or other data.

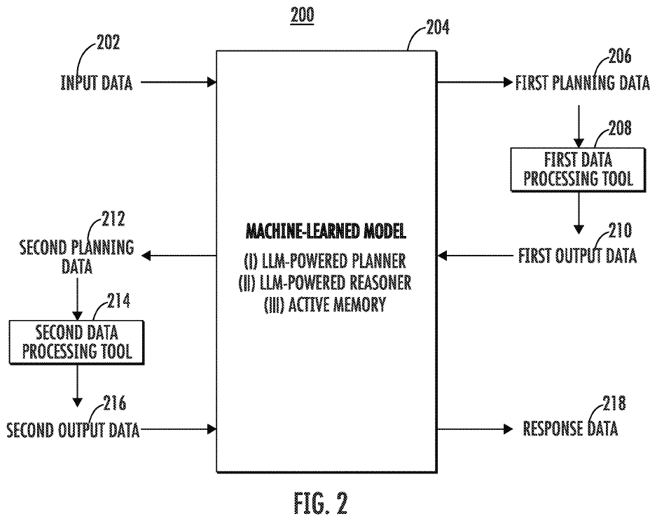

FIG. 2 depicts a block diagram of an example visual information seeking system 200 according to example embodiments of the present disclosure. The visual information seeking system 200 is similar to the visual information determination system 10 of FIG. 1 except that the visual information seeking system 200 further includes a first data processing tool 208 and a second data processing tool 214. For example, the visual information seeking system 200 can utilize any number of different data processing tools to perform visual information seeking.

In particular, input data 202 can be obtained from a user computing system. The input data 202 can be descriptive of a query associated with one or more features in one or more images of the input data 202. The input data 202 may be obtained via one or more user interfaces.

The input data 202 can be processed with a machine-learned model 204 to generate first planning data 206. The machine-learned model 204 can include an LLM-powered planner block, an LLM-powered reasoner block, and an active memory. The LLM-powered planner block can determine when, what, and how to utilize one or more data processing tools. The LLM-powered reasoner block can extract relevant information from the outputs of the data processing tools. Additionally and/or alternatively, the LLM-powered planner block can determine when enough information is obtained to respond to the query. The active memory can continually obtain and store the data obtained and/or generated throughout the visual information seeking process.

The first planning data 206 can include an application programming interface call to transmit a first set of data to a first data processing tool 208. The first set of data can include a portion of the input data 202 and/or a model-generated dataset. The first data processing tool 208 can process the first set of data to generate first output data 210.

The first output data 210 can be obtained then processed with the machine-learned model 204 to generate second planning data 212. The second planning data 212 can include an application programming interface call to transmit a second set of data to a second data processing tool 214. The second set of data can include a portion of the input data 202, a portion of the first output data 210, and/or a model-generated dataset. The second data processing tool 214 can process the second set of data to generate second output data 216.

The first data processing tool 208 and the second data processing tool 214 may differ. For example, the first data processing tool 208 may include an image segmentation model and an object classification model, and the second data processing tool 214 may include one or more search engines.

The second output data 216 can be obtained and processed with the machine-learned model 204. The input data 202, the first output data 210, and/or the second output data 216 can then be utilized to generate response data 218 descriptive of a response to the query of the input data 202.

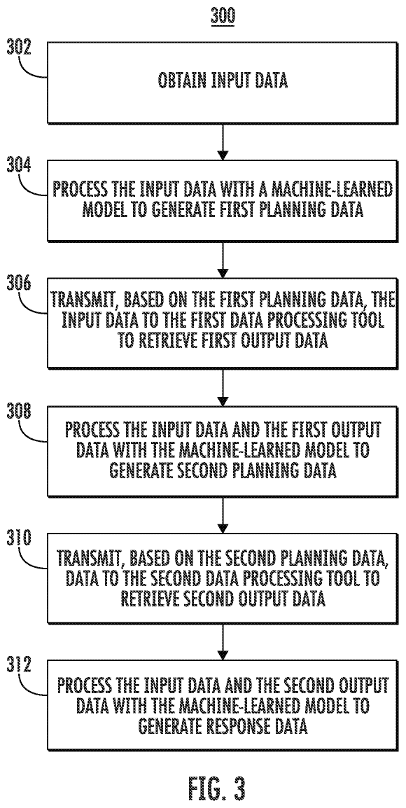

FIG. 3 depicts a flow chart diagram of an example method to perform according to example embodiments of the present disclosure. Although FIG. 3 depicts steps performed in a particular order for purposes of illustration and discussion, the methods of the present disclosure are not limited to the particularly illustrated order or arrangement. The various steps of the method 300 can be omitted, rearranged, combined, and/or adapted in various ways without deviating from the scope of the present disclosure.

At 302, a computing system can obtain input data. The input data can include image data and text data. The text data can include a query associated with the image data. The image data can include one or more objects. Additionally and/or alternatively, the text data can be descriptive of one or more questions associated with object details for one or more objects depicted in one or more images of the image data (e.g., “What year was this building built?”, “What type of bird is this?”, and/or “How do you make this thing?”).

At 304, the computing system can process the input data with a machine-learned model to generate first planning data. The first planning data can be descriptive of instructions to provide the input data to a first data processing tool. In some implementations, the first data processing tool can include an object detection model. The machine-learned model can include an autoregressive language model. In some implementations, the machine-learned model may be conditioned (e.g., parameter tuned and/or few shot example conditioned) for visual information seeking based planning and/or visual information seeking based reasoning. For example, the machine-learned model may be conditioned to determine when and/or what application programming interface calls are to be performed for different visual information seeking tasks. The machine-learned model may be conditioned to process the received outputs from the application programming interface calls to determine when and/or what relevant information was retrieved. In some implementations, the machine-learned model may be conditioned to iteratively determine API calls and process API outputs until a determined end output is received. The end output may then be processed to generate a response.

At 306, the computing system can transmit, based on the first planning data, the input data to the first data processing tool to retrieve first output data. The first output data can include one or more bounding boxes associated with one or more objects in the image data. In some implementations, the first output data can include one or more segmented portions of one or more images of the image data and caption data associated with the one or more segmented portions. The caption data can be descriptive of an object classification associated with one or more objects detected in the one or more segmented portions of one or more images.

At 308, the computing system can process the input data and the first output data with the machine-learned model to generate second planning data. The second planning data can be descriptive of instructions to transmit data to a second data processing tool. The second data processing tool can include a search engine. In some implementations, the second planning data can include a model-generated query. The model-generated query can be transmitted to the second data processing tool to retrieve the second output data. In some implementations, the model-generated query can be generated based on the input data and the first output data. The model-generated query can be descriptive of the query of the input data modified based on the first output data.

At 310, the computing system can transmit, based on the second planning data, data to the second data processing tool to retrieve second output data. The first planning data and/or the second planning data may include a model-generated query that may be provided to and/or processed with the respective data processing model associated with the planning data. The second data processing tool may receive data via an application programming interface that was instructed to transmit the data based on the second planning data.

At 312, the computing system can process the input data and the second output data with the machine-learned model to generate response data. The response data can be descriptive of a response to the query. The response data can include a natural language text string that is responsive to the query of the input data.

In some implementations, the computing system can process the input data and the second output data with the machine-learned model to generate third planning data. The third planning data can be descriptive of instructions to transmit data to a third data processing tool. The computing system can transmit, based on the third planning data, data to the third data processing tool to retrieve third output data and can process the input data and the third output data with the machine-learned model to generate the response data.

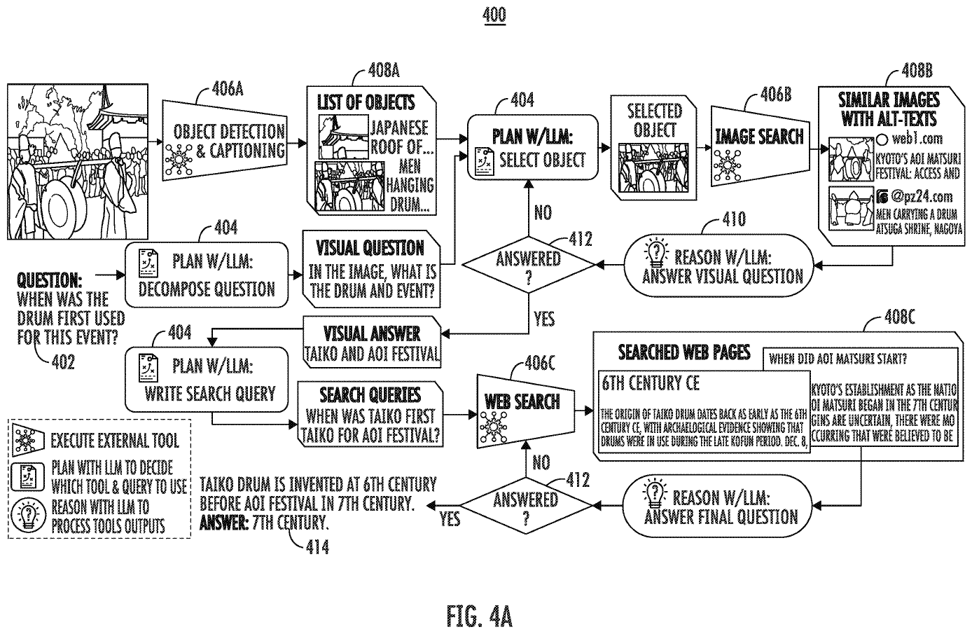

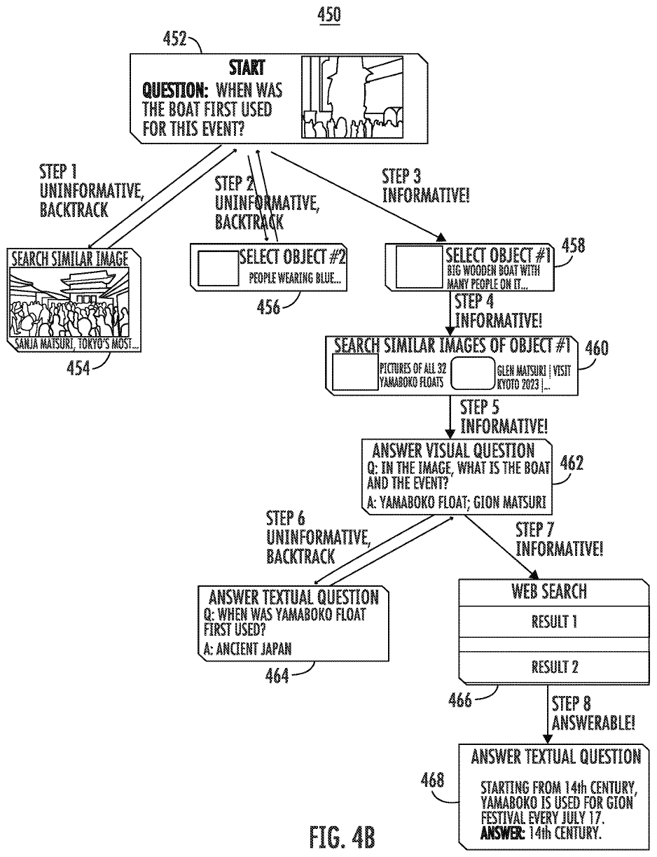

FIG. 4A depicts a block diagram of an example automated visual information seeking system 400 according to example embodiments of the present disclosure. The automated visual information seeking system 400 can obtain an image (e.g., an image depicting a parade ceremony) and a question 402 associated with the image (e.g., “When was the drum first used for this event?”). The question 402 can be processed with a plan with a large language model block 404, which may decompose the question and determine the image is to be transmitted to an object detection and captioning tool 406A. Additionally, the plan with a large language model block 404 may generate a visual question (e.g., “In the image, what is the drum and event?”). The tool call and the visual question may be part of a first planning dataset.

The object detection and captioning tool 406A can process the image to generate a list of objects 408A that includes one or more segmented portions of the image with determined captions for each of the respective segmented portions. The segmented portions, respective captions, and the visual question may be processed with the plan with a large language model block 404 to generate second planning data. The second planning data can select a particular segmented portion and respective caption. The selected segmented portion of the image can then be transmitted to an image search tool 406B based on the second planning data.

The image search tool 406B can process the selected segmented portion to identify similar images with alt-texts 408B (e.g., web descriptions associated with similar images to the segmented portion).

The similar images with alt-texts 408B can then be processed with a reason with the large language model block 410 to generate an answer to the visual question. The machine-learned model can then determine if the visual question is answered 412 and whether or not other segmented portions are to be processed with the image search tool 406B and/or another tool.

The visual answer can then be processed with the plan with a large language model block 404 to generate third planning data. The third planning data can include a generated search query that includes the information from the visual answer (e.g., “When was Taiko first used for Aoi Festival?”) and an application programming interface call to transmit the generated search query to a web search tool 406C.

The web search tool 406C can process the search query to determine search results including searched web pages 408C. The information scraped (or extracted) from the relevant searched web pages 408C can be processed with the reason with the large language model block 410 to generate an answer to the search query. The machine-learned model can determine whether the search query is answered 412 or whether further searching and scraping is to be performed.

If the search query is answered, the response data descriptive of the response 414 to the search query can then be provided to the user that submitted the question 402 and image.

FIG. 4B depicts a block diagram of an example automated visual information seeking workflow system 450 according to example embodiments of the present disclosure. In particular, the automated visual information seeking workflow system 450 can obtain a multimodal query 452 (e.g., an image and a question) and generate a response 468 (e.g., an answer generated based on multi-tool usage) based on a plurality of processing instances with a plurality of different tools.

A multimodal query 452 can be obtained from a user computing system. The multimodal query 452 can include an image and a text string descriptive of a question about one or more details from the image. The multimodal query 452 may be processed with the planner model to determine one or more processing actions (e.g., using one or more processing tools).

An image search may first be performed with a search engine to determine an image search result 454 (e.g., a similar image and related metadata (e.g., a caption, entity tags, and/or location information). The image search may include embedding the image of the multimodal query 452 then performing a nearest neighbor embedding determination. Alternatively and/or additionally, the image search may include image matching.

The image search may be determined to be uninformative, which may lead to backtracking. The planner model may process the image search result 454 and the multimodal query 452 to determine a next action (e.g., a different processing tool).

A particular object 456 may be selected based on one or more factors, which may include foreground determination, focus determination, and/or selection based on the content of the text string. The particular object 456 can be detected with a detection model then segmented with a segmentation model.

The object selection may be determined to be uninformative, which may lead to backtracking. The planner model may process the particular object 456, the image search result 454, and the multimodal query 452 to determine a next action (e.g., a different processing tool).

A second particular object 458 may be selected based on one or more factors, which may include foreground determination, focus determination, and/or selection based on the content of the text string. The second particular object 458 can be detected with a detection model then segmented with a segmentation model.

The second particular object 458 may be determined to be informative by the reasoner model and/or the planner model. The planner model can then determine a next action based on the second particular object 458 and the multimodal query 452.

An image search (e.g., with a search engine) can be performed by processing the image segmented that includes the second particular object 458 to determine a respective search result set 460. The respective search result set 460 can include images, knowledge graph data, web resource data, captions, location data, and/or text content data.

The respective search result set 460 may be determined to be informative by the reasoner model and/or the planner model. The planner model can then determine a next action based on the respective search result set 460, the second particular object 458, and the multimodal query 452.

The respective search result set 460 and the multimodal query 452 can be processed with a generative language model (e.g., the reasoner model and/or planner model) to perform visual question answering to answer a reasoner model generated question 462. The answer to the reasoner model generated question 462, the respective search result set 460, and the multimodal query 452 can be processed with a generative language model (e.g., the reasoner model and/or planner model) to generate a first predicted answer 464. The reasoner model and/or the planner model may determine the first predicted answer 464 is incorrect and/or uninformative.

A search (e.g., with a search engine) may then be performed based on the multimodal query 452 and/or the answer to the reasoner model generated question 462 to determine web search results 466.

The web search results 466 and the multimodal query 452 may then be processed with a generative model (e.g., the reasoner model and/or the planner model) to generate a second predicted answer. The second predicted answer may be determine to be accurate and may be provided as the response 468.

In particular, the automated visual information seeking workflow system 450 can leverage a planner model and/or a reasoner model to determine how to process the multimodal query 452 and successive data instances. The process can include performing a plurality of subtasks, which may include utilizing a plurality of different processing tools based on determinations performed by the planner model and/or the reasoner model. The automated visual information seeking workflow system 450 may generate a plurality of model-generated queries based on the initial multimodal query 452 in order to respond to the multimodal query 452. The plurality of model-generated queries may include multimodal queries, which may include all and/or portions of the original image. The plurality of model-generated queries may include outputs from the one or more processing tools as different tasks are being performed.

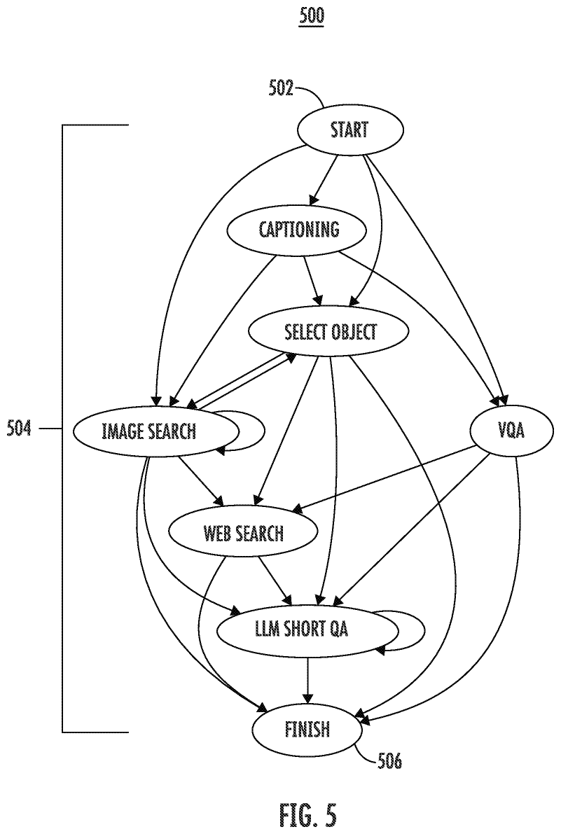

FIG. 5 depicts a block diagram of an example API tool call system 500 according to example embodiments of the present disclosure. API tool call system 500 of the systems and methods disclosed herein can include a machine-learned model being leveraged to determine when, what, and how to utilize a plurality of data processing tools 504 to generate a response to an input prompt.

The API tool call system 500 can start 502 with an input prompt that may include text data, image data, audio data, latent encoding data, multimodal data, statistical data, and/or other data and may finish 506 with a response to the input prompt. Generating a response to the input prompt can involve a machine-learned model iteratively obtaining and processing data to determine application programming interface calls that can be performed to utilize a plurality of data processing tools 504 for responding to the input prompt.

The plurality of data processing tools 504 can include a captioning tool, a select object tool, a visual question answering tool, an image search tool, a web search tool, a large language model short question-and-answer tool, and/or other tools. The plurality of data processing tools 504 may process the input prompt model-generated data, and/or the outputs of other tools.

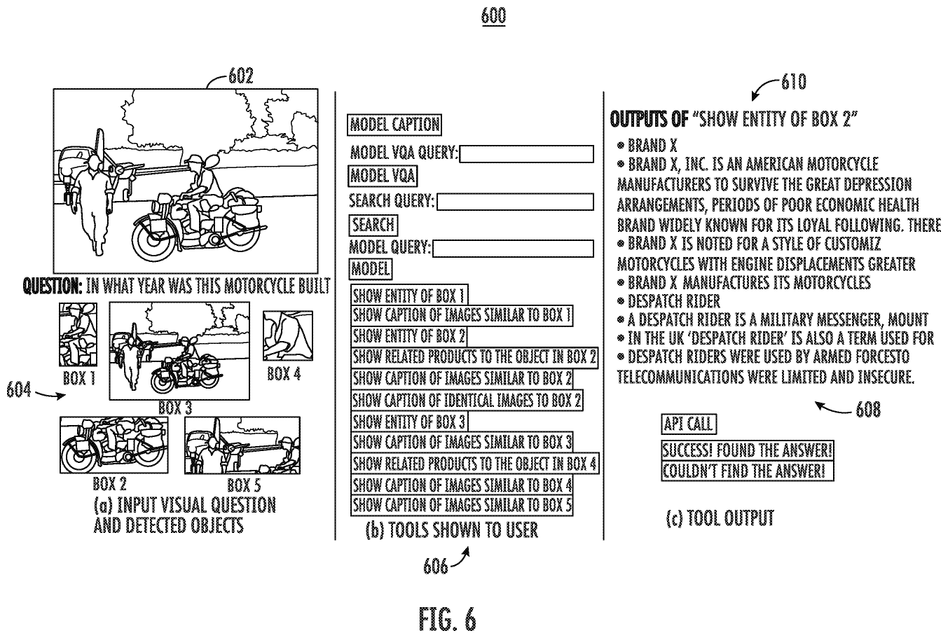

FIG. 6 depicts an illustration of an example user data collection interface 600 according to example embodiments of the present disclosure. The user data collection interface 600 can include a plurality of user interface elements that can be interacted with to collect user data to generate few shot examples to condition a machine-learned model for visual information seeking planning and reasoning.

For example, the user data collection interface 600 may display an input prompt 602 including an example input image and an example input question. A plurality of image segments 604 of the input example image can then be provided to a user to be selected for obtaining selected image segment data.

A tools interface 606 can then be displayed to allow a user to select which data processing tools they would utilize to answer the question including what data they would provide to the data processing tool. The output(s) 610 of a selected data processing tool can be obtained and provided to a user for display.

The user may then be provided with a plurality of output reasoning interface elements 608 for display. The user can then select whether the output(s) 610 are useful, whether the end answer has been determined, whether an additional application programming interface call is to be performed, and/or if the answer cannot be found.

The user data collection interface 600 may be provided to a plurality of different users for a plurality of different visual information seeking tasks. The collected user behavior data can then be utilized to generate a transition graph that may be utilized by a pre-trained machine-learned language model for planning and reasoning.

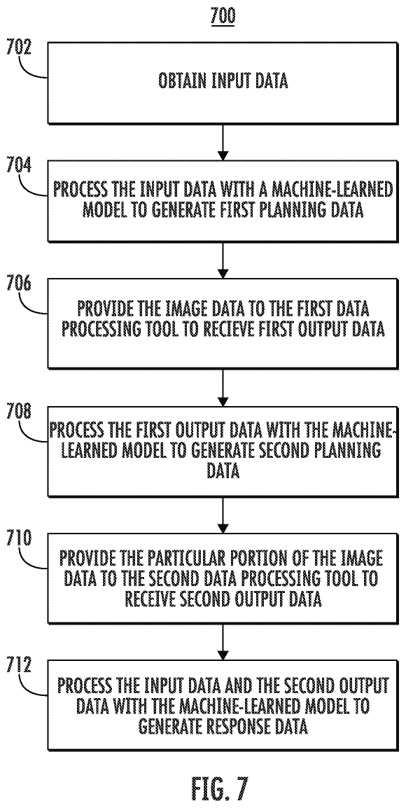

FIG. 7 depicts a flow chart diagram of an example method to perform according to example embodiments of the present disclosure. Although FIG. 7 depicts steps performed in a particular order for purposes of illustration and discussion, the methods of the present disclosure are not limited to the particularly illustrated order or arrangement. The various steps of the method 700 can be omitted, rearranged, combined, and/or adapted in various ways without deviating from the scope of the present disclosure.

At 702, a computing system can obtain input data. The input data can include image data and text data. The text data can include a query associated with the image data. The input data may include text data, image data, audio data, video data, latent encoding data, statistical data, multimodal data, and/or other data. The image data may be descriptive of one or more images captured with a user computing device. Alternatively and/or additionally, the image data may be descriptive of one or more images obtained from one or more web resources.

At 704, the computing system can process the input data with a machine-learned model to generate first planning data. The first planning data can be descriptive of instructions to provide the image data to a first data processing tool. The first planning data may include a model-generated text string to be processed with the image data.

In some implementations, the machine-learned model may have been conditioned on a training dataset including a plurality of training examples. Each training example of the plurality of training examples can include a training input, a training output, and a training rationale. The training rationale can be descriptive of a sequence of processing instances and tool calls for determining the output data. Additionally and/or alternatively, the machine-learned model may have been conditioned on a training dataset including sequence data. The sequence data can be descriptive of a sequence of actions for generating a training response in response to obtaining a particular type of input. In some implementations, the machine-learned model may have been conditioned on human input data descriptive of actions a human selected as being particular actions to perform when a particular input type is received. The human input data may have been obtained via a user interface that provides a plurality of selectable options for a user. The plurality of selectable options can include a plurality of external tools to call and a final output option.

At 706, the computing system can provide the image data to the first data processing tool to receive first output data. The first output data can be generated with the first data processing tool based on the image data. Alternatively and/or additionally, model-generated data and/or the text data may be provided to the first data processing tool to generate the first output data. The first data processing tool may include an image processing tool, a text processing tool, a search engine, an augmentation model, and/or another data processing tool. The first output data can include text data, audio data, image data, latent encoding data, multimodal data, and/or other data.

At 708, the computing system can process the first output data with the machine-learned model to generate second planning data. The second planning data can be descriptive of instructions to provide a particular portion of the image data to a second data processing tool. The second planning data can include model-generated data to provide to the second data processing tool. The model-generated data can include text data, image data, audio data, latent encoding data, multimodal data, and/or other data. The second data processing tool can include an image processing model, a search engine, a segmentation model, an augmentation model, and/or another data processing tool.

At 710, the computing system can provide the particular portion of the image data to the second data processing tool to receive second output data. The second output data can be generated with the second data processing tool based on the particular portion of the image data. The second data processing tool may perform a reverse image search to obtain data associated with an object depicted in the particular portion of the image data.

At 712, the computing system can process the text data and the second output data with the machine-learned model to generate response data. The response data can be descriptive of a response to the query. The response data can include text data, image data, audio data, latent encoding data, augmented reality data, virtual reality data, multimodal data, and/or other data. The response data may include a natural language text string descriptive of the response.

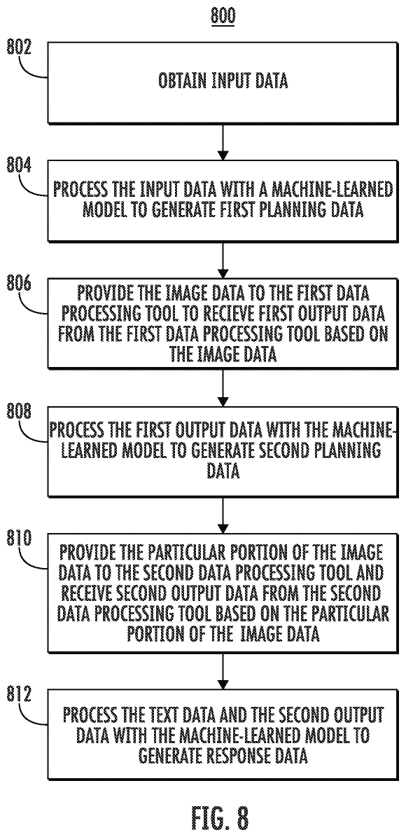

FIG. 8 depicts a flow chart diagram of an example method to perform according to example embodiments of the present disclosure. Although FIG. 8 depicts steps performed in a particular order for purposes of illustration and discussion, the methods of the present disclosure are not limited to the particularly illustrated order or arrangement. The various steps of the method 800 can be omitted, rearranged, combined, and/or adapted in various ways without deviating from the scope of the present disclosure.

At 802, a computing system can obtain input data. The input data can include image data and text data. The text data can include a query associated with the image data. In some implementations, the query can be descriptive of a question associated with a particular object depicted in the image data.

At 804, the computing system can process the input data with a machine-learned model to generate first planning data. The first planning data can be descriptive of instructions to provide the image data to a first data processing tool.

At 806, the computing system can provide the image data to the first data processing tool and receive first output data from the first data processing tool based on the image data.

In some implementations, the first data processing tool can detect a plurality of objects depicted in the image data, generate a plurality of bounding boxes associated with the plurality of objects, generate a plurality of image segments based on the plurality of bounding boxes, classify each of the plurality of objects in the plurality of image segments to generate a plurality of object classifications, and generate the first output data. The first output data can include the plurality of image segments and the plurality of object classifications.

At 808, the computing system can process the first output data with the machine-learned model to generate second planning data. The second planning data can be descriptive of instructions to provide a particular portion of the image data to a second data processing tool.

At 810, the computing system can provide the particular portion of the image data to the second data processing tool and receive second output data from the second data processing tool based on the particular portion of the image data.

In some implementations, the second data processing tool can include an image search engine. The second data processing tool can process one or more of the plurality of image segments with the image search engine to determine one or more web resources associated with the one or more of the plurality of image segments. The one or more of the plurality of image segments can be selected by the machine-learned model based on the input data and the plurality of object classifications. Additionally and/or alternatively, the second data processing tool can generate the second output data based on the one or more web resources.

At 812, the computing system can process the text data and the second output data with the machine-learned model to generate response data. The response data can be descriptive of a response to the query.

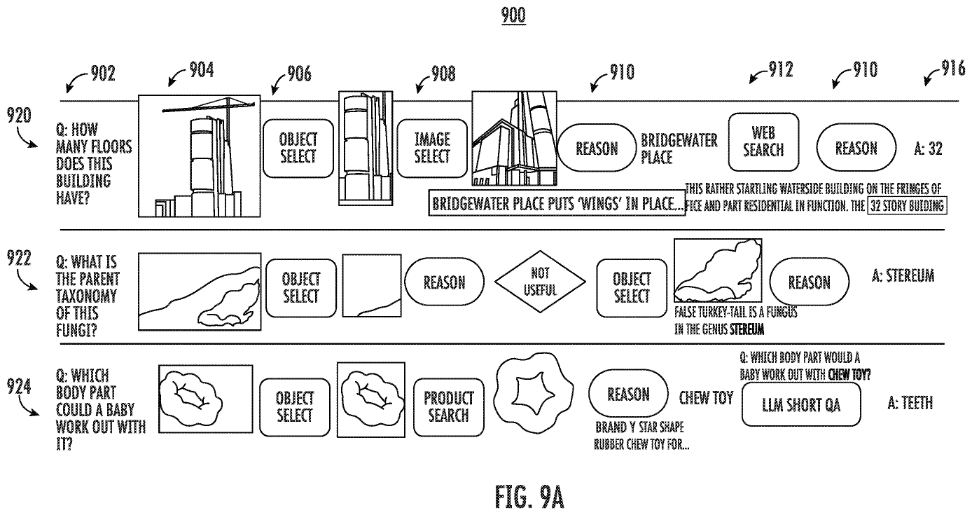

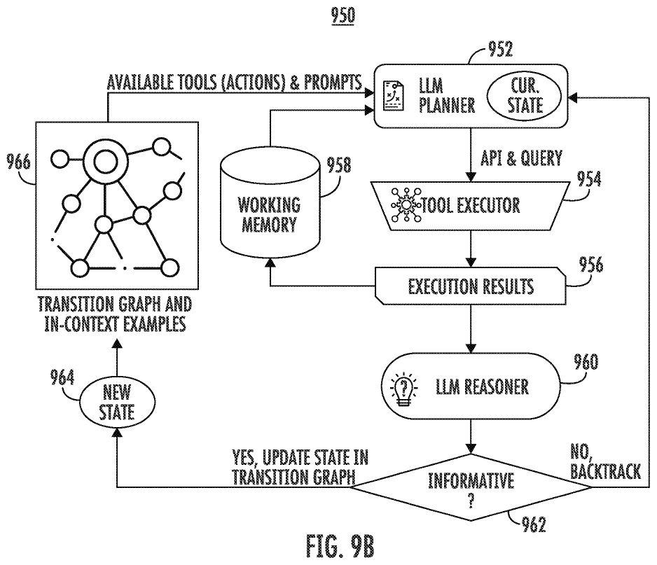

FIG. 9A depicts an illustration of an example visual information determination process 900 according to example embodiments of the present disclosure. In particular, FIG. 9 depicts three example processes (920, 922, & 924).

At 920, a question 902 (“How many floors does this building have?”) and an image 904 (an image of a building) can be obtained. An object selection 906 can occur to select a relevant image segment associated with the question 902. The image segment can then be processed with an image search tool 908 to identify similar images and relevant text data associated with the identified similar images. The similar image(s) and respective relevant text data can be processed with a language model reasoner block 910 to determine a relevant answer to what the building is. The building name can then be processed with a web search tool 912 to obtain one or more search results. Relevant search result information can then be extracted using the language model reasoner block 910 to determine an answer 916 to the input question 902.

At 922, a similar process can be performed that may include a second object selection 906 loop based on a determined object identification being irrelevant based on processing a tool output with the language model reasoner block 910.

At 924, a similar process to 920 and 922 can be performed that may include the utilization of an LLM short QA tool for answering the input question 902.

FIG. 9B depicts an illustration of an example visual query processing system 950 according to example embodiments of the present disclosure. The visual query processing system 950 can employ dynamic decision-making to plan (e.g., find optimal tool and query), execute results, and then reason (e.g., estimate whether continue or backtrack).

The visual query processing system 950 can obtain a visual query. The visual query can be processed with the planner model 952 (e.g., a generative language model (e.g., an LLM)). The visual query processing system 950 may begin processing with an initial query (e.g., a multimodal visual query). As additional information is retrieved, the initial query may be updated.

The initial query can be processed with the planner model 952 to determine a particular action to perform, which may cause an application programming interface call to be generated. The application programming interface call can then be performed to transmit the initial query and instructions to a tool executor 954 to generate and/or obtain execution results 956. The tool executor may execute the tool interactions to communicate with the one or more processing tools (e.g., image search engine, web search engine, vision language model, captioning model, VQA model processing, detection model, segmentation model, augmentation model, etc.).

The execution results 956 may be transmitted to a working memory 958 and may be utilized for future planning instances with the planner model 952. The query state may be updated based on the execution results 956.

The execution results 956 can be processed with a reasoner model 960 (e.g., a generative language model (e.g., an LLM)) to determine whether the execution results 956 are informative 962. If the execution results 956 are determined to not be informative, the visual query processing system 950 may backtrack and perform another planning instance with the planner model 952. If the execution results 956 are determined to be informative, the query state may be updated based on the execution results 956 to generate an updated query 964, which may include updating and/or utilizing transition graphs 966 and/or in-context examples.

The updated query 964, the transition graphs 966, and/or in-context examples may then be transmitted to the planner model to determine additional actions and/or prompts to leverage to perform the response generation. The loop can be performed iteratively and may include five or more loops before response generation.

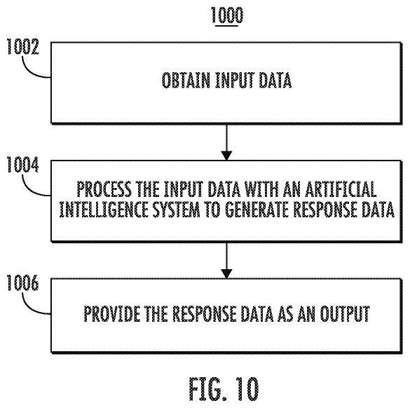

FIG. 10 depicts a flow chart diagram of an example method to perform according to example embodiments of the present disclosure. Although FIG. 10 depicts steps performed in a particular order for purposes of illustration and discussion, the methods of the present disclosure are not limited to the particularly illustrated order or arrangement. The various steps of the method 1000 can be omitted, rearranged, combined, and/or adapted in various ways without deviating from the scope of the present disclosure.

At 1002, a computing system can obtain input data. The input data can include image data and text data. The text data can include a query associated with the image data. The input data may be obtained via a graphical user interface, which may include a query input box, a selection window, and/or a download portal.

At 1004, the computing system can process the input data with an artificial intelligence system to generate response data. The response data can be descriptive of a response to the query. The artificial intelligence system can include a language model planner block, a language model reasoner block, and a working memory. In some implementations, the language model planner block may have been conditioned to determine one or more data processing tools to utilize for processing data associated with responding to the query. Additionally and/or alternatively, the language model reasoner block may have been conditioned to process outputs of the one or more data processing tools to determine information associated with responding to the query. The working memory can store acquired information obtained and generated with the artificial intelligence system.

In some implementations, the artificial intelligence system can include one or more machine-learned models conditioned on user behavior data. The user behavior data can be processed to generate a transition graph that is descriptive of a determined sequence of decisions made by users when performing a particular information seeking task. In some implementations, the transition graph can be descriptive of a plurality of distinct states and can indicate a particular set of actions available at each state of the plurality of distinct states. Additionally and/or alternatively, the user behavior data may be utilized to condition the language model planner block and the language model reasoner block for particular context-based processing.

In some implementations, the one or more data processing tools can include a computer vision tool, a web search tool, and/or an image search tool. The computer vision tool can include an object detection model, an optical character recognition model, an image captioning model, and/or a visual question-and-answer model. Additionally and/or alternatively, the web search tool can retrieve open world knowledge from web resources. The image search tool may identify relevant information from metadata associated with visually similar images. In some implementations, the language model planner block may have been conditioned to generate a processing tool query to provide to the one or more data processing tools based on the input data.

At 1006, the computing system can provide the response data as an output. The response data may be provided to a user via a graphical user interface. For example, the graphical user interface may be a search interface, and the response data may be provided for display in a panel adjacent to one or more search results.

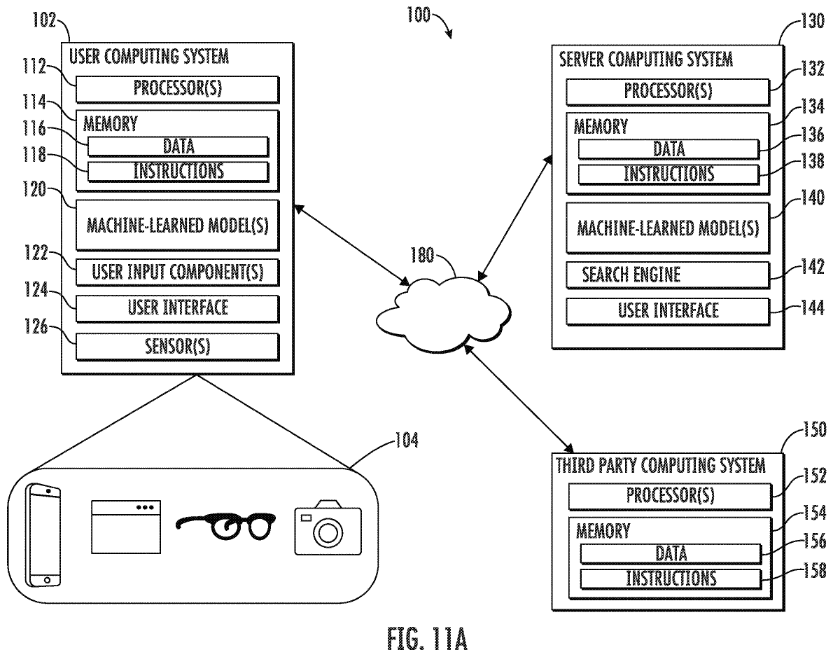

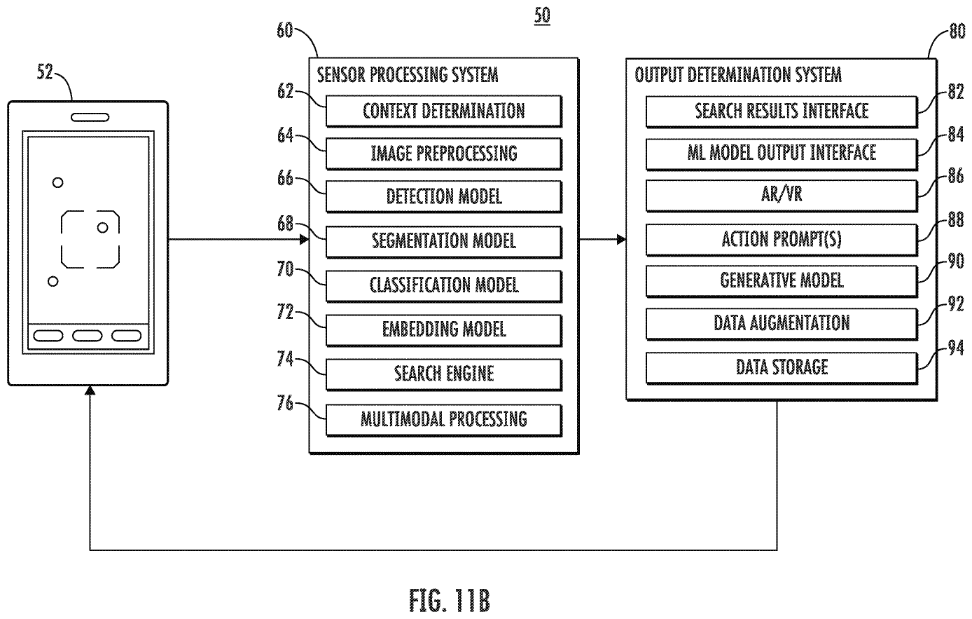

FIG. 11A depicts a block diagram of an example computing system 100 that performs visual query processing according to example embodiments of the present disclosure. The system 100 includes a user computing system 102, a server computing system 130, and/or a third computing system 150 that are communicatively coupled over a network 180.

The user computing system 102 can include any type of computing device, such as, for example, a personal computing device (e.g., laptop or desktop), a mobile computing device (e.g., smartphone or tablet), a gaming console or controller, a wearable computing device, an embedded computing device, or any other type of computing device.

The user computing system 102 includes one or more processors 112 and a memory 114. The one or more processors 112 can be any suitable processing device (e.g., a processor core, a microprocessor, an ASIC, a FPGA, a controller, a microcontroller, etc.) and can be one processor or a plurality of processors that are operatively connected. The memory 114 can include one or more non-transitory computer-readable storage mediums, such as RAM, ROM, EEPROM, EPROM, flash memory devices, magnetic disks, etc., and combinations thereof. The memory 114 can store data 116 and instructions 118 which are executed by the processor 112 to cause the user computing system 102 to perform operations.

In some implementations, the user computing system 102 can store or include one or more machine-learned models 120. For example, the machine-learned models 120 can be or can otherwise include various machine-learned models such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks.

In some implementations, the one or more machine-learned models 120 can be received from the server computing system 130 over network 180, stored in the user computing device memory 114, and then used or otherwise implemented by the one or more processors 112. In some implementations, the user computing system 102 can implement multiple parallel instances of a single machine-learned model 120 (e.g., to perform parallel machine-learned model processing across multiple instances of input data and/or detected features).

More particularly, the one or more machine-learned models 120 may include one or more detection models, one or more classification models, one or more segmentation models, one or more augmentation models, one or more generative models, one or more natural language processing models, one or more optical character recognition models, and/or one or more other machine-learned models. The one or more machine-learned models 120 can include one or more transformer models. The one or more machine-learned models 120 may include one or more neural radiance field models, one or more diffusion models, and/or one or more autoregressive language models.

The one or more machine-learned models 120 may be utilized to detect one or more object features. The detected object features may be classified and/or embedded. The classification and/or the embedding may then be utilized to perform a search to determine one or more search results. Alternatively and/or additionally, the one or more detected features may be utilized to determine an indicator (e.g., a user interface element that indicates a detected feature) is to be provided to indicate a feature has been detected. The user may then select the indicator to cause a feature classification, embedding, and/or search to be performed. In some implementations, the classification, the embedding, and/or the searching can be performed before the indicator is selected.

In some implementations, the one or more machine-learned models 120 can process image data, text data, audio data, and/or latent encoding data to generate output data that can include image data, text data, audio data, and/or latent encoding data. The one or more machine-learned models 120 may perform optical character recognition, natural language processing, image classification, object classification, text classification, audio classification, context determination, action prediction, image correction, image augmentation, text augmentation, sentiment analysis, object detection, error detection, inpainting, video stabilization, audio correction, audio augmentation, and/or data segmentation (e.g., mask based segmentation).

Machine-learned model(s) can be or include one or multiple machine-learned models or model components. Example machine-learned models can include neural networks (e.g., deep neural networks). Example machine-learned models can include non-linear models or linear models. Example machine-learned models can use other architectures in lieu of or in addition to neural networks. Example machine-learned models can include decision tree based models, support vector machines, hidden Markov models, Bayesian networks, linear regression models, k-means clustering models, etc.

Example neural networks can include feed-forward neural networks, recurrent neural networks (RNNs), including long short-term memory (LSTM) based recurrent neural networks, convolutional neural networks (CNNs), diffusion models, generative-adversarial networks, or other forms of neural networks. Example neural networks can be deep neural networks. Some example machine-learned models can leverage an attention mechanism such as self-attention. For example, some example machine-learned models can include multi-headed self-attention models.

Machine-learned model(s) can include a single or multiple instances of the same model configured to operate on data from input(s). Machine-learned model(s) can include an ensemble of different models that can cooperatively interact to process data from input(s). For example, machine-learned model(s) can employ a mixture-of-experts structure. See, e.g., Zhou et al., Mixture-of-Experts with Expert Choice Routing, ARXIV: 2202.09368v2 (Oct. 14, 2022).

Input(s) can generally include or otherwise represent various types of data. Input(s) can include one type or many different types of data. Output(s) can be data of the same type(s) or of different types of data as compared to input(s). Output(s) can include one type or many different types of data.

Example data types for input(s) or output(s) include natural language text data, software code data (e.g., source code, object code, machine code, or any other form of computer-readable instructions or programming languages), machine code data (e.g., binary code, assembly code, or other forms of machine-readable instructions that can be executed directly by a computer's central processing unit), assembly code data (e.g., low-level programming languages that use symbolic representations of machine code instructions to program a processing unit), genetic data or other chemical or biochemical data, image data, audio data, audiovisual data, haptic data, biometric data, medical data, financial data, statistical data, geographical data, astronomical data, historical data, sensor data generally (e.g., digital or analog values, such as voltage or other absolute or relative level measurement values from a real or artificial input, such as from an audio sensor, light sensor, displacement sensor, etc.), and the like. Data can be raw or processed and can be in any format or schema.

In multimodal inputs or outputs, example combinations of data types include image data and audio data, image data and natural language data, natural language data and software code data, image data and biometric data, sensor data and medical data, etc. It is to be understood that any combination of data types in an input or an output can be present.

An example input can include one or multiple data types, such as the example data types noted above. An example output can include one or multiple data types, such as the example data types noted above. The data type(s) of input can be the same as or different from the data type(s) of output. It is to be understood that the example data types noted above are provided for illustrative purposes only. Data types contemplated within the scope of the present disclosure are not limited to those examples noted above.

Additionally or alternatively, one or more machine-learned models 140 can be included in or otherwise stored and implemented by the server computing system 130 that communicates with the user computing system 102 according to a client-server relationship. For example, the machine-learned models 140 can be implemented by the server computing system 140 as a portion of a web service (e.g., a viewfinder service, a visual search service, an image processing service, an ambient computing service, and/or an overlay application service). Thus, one or more models 120 can be stored and implemented at the user computing system 102 and/or one or more models 140 can be stored and implemented at the server computing system 130.

The user computing system 102 can also include one or more user input component 122 that receives user input. For example, the user input component 122 can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other means by which a user can provide user input.

In some implementations, the user computing system can store and/or provide one or more user interfaces 124, which may be associated with one or more applications. The one or more user interfaces 124 can be configured to receive inputs and/or provide data for display (e.g., image data, text data, audio data, one or more user interface elements, an augmented-reality experience, a virtual reality experience, and/or other data for display. The user interfaces 124 may be associated with one or more other computing systems (e.g., server computing system 130 and/or third party computing system 150). The user interfaces 124 can include a viewfinder interface, a search interface, a generative model interface, a social media interface, and/or a media content gallery interface.

The user computing system 102 may include and/or receive data from one or more sensors 126. The one or more sensors 126 may be housed in a housing component that houses the one or more processors 112, the memory 114, and/or one or more hardware components, which may store, and/or cause to perform, one or more software packets. The one or more sensors 126 can include one or more image sensors (e.g., a camera), one or more lidar sensors, one or more audio sensors (e.g., a microphone), one or more inertial sensors (e.g., inertial measurement unit), one or more biological sensors (e.g., a heart rate sensor, a pulse sensor, a retinal sensor, and/or a fingerprint sensor), one or more infrared sensors, one or more location sensors (e.g., GPS), one or more touch sensors (e.g., a conductive touch sensor and/or a mechanical touch sensor), and/or one or more other sensors. The one or more sensors can be utilized to obtain data associated with a user's environment (e.g., an image of a user's environment, a recording of the environment, and/or the location of the user).

The user computing system 102 may include, and/or pe part of, a user computing device 104. The user computing device 104 may include a mobile computing device (e.g., a smartphone or tablet), a desktop computer, a laptop computer, a smart wearable, and/or a smart appliance. Additionally and/or alternatively, the user computing system may obtain from, and/or generate data with, the one or more one or more user computing devices 104. For example, a camera of a smartphone may be utilized to capture image data descriptive of the environment, and/or an overlay application of the user computing device 104 can be utilized to track and/or process the data being provided to the user. Similarly, one or more sensors associated with a smart wearable may be utilized to obtain data about a user and/or about a user's environment (e.g., image data can be obtained with a camera housed in a user's smart glasses). Additionally and/or alternatively, the data may be obtained and uploaded from other user devices that may be specialized for data obtainment or generation.

The server computing system 130 includes one or more processors 132 and a memory 134. The one or more processors 132 can be any suitable processing device (e.g., a processor core, a microprocessor, an ASIC, a FPGA, a controller, a microcontroller, etc.) and can be one processor or a plurality of processors that are operatively connected. The memory 134 can include one or more non-transitory computer-readable storage mediums, such as RAM, ROM, EEPROM, EPROM, flash memory devices, magnetic disks, etc., and combinations thereof. The memory 134 can store data 136 and instructions 138 which are executed by the processor 132 to cause the server computing system 130 to perform operations.

In some implementations, the server computing system 130 includes or is otherwise implemented by one or more server computing devices. In instances in which the server computing system 130 includes plural server computing devices, such server computing devices can operate according to sequential computing architectures, parallel computing architectures, or some combination thereof.

As described above, the server computing system 130 can store or otherwise include one or more machine-learned models 140. For example, the models 140 can be or can otherwise include various machine-learned models. Example machine-learned models include neural networks or other multi-layer non-linear models. Example neural networks include feed forward neural networks, deep neural networks, recurrent neural networks, and convolutional neural networks. Example models 140 are discussed with reference to FIG. 9B.

Additionally and/or alternatively, the server computing system 130 can include and/or be communicatively connected with a search engine 142 that may be utilized to crawl one or more databases (and/or resources). The search engine 142 can process data from the user computing system 102, the server computing system 130, and/or the third party computing system 150 to determine one or more search results associated with the input data. The search engine 142 may perform term based search, label based search, Boolean based searches, image search, embedding based search (e.g., nearest neighbor search), multimodal search, and/or one or more other search techniques.

The server computing system 130 may store and/or provide one or more user interfaces 144 for obtaining input data and/or providing output data to one or more users. The one or more user interfaces 144 can include one or more user interface elements, which may include input fields, navigation tools, content chips, selectable tiles, widgets, data display carousels, dynamic animation, informational pop-ups, image augmentations, text-to-speech, speech-to-text, augmented-reality, virtual-reality, feedback loops, and/or other interface elements.

The user computing system 102 and/or the server computing system 130 can train the models 120 and/or 140 via interaction with the third party computing system 150 that is communicatively coupled over the network 180. The third party computing system 150 can be separate from the server computing system 130 or can be a portion of the server computing system 130. Alternatively and/or additionally, the third party computing system 150 may be associated with one or more web resources, one or more web platforms, one or more other users, and/or one or more contexts.

An example machine-learned model can include a generative model (e.g., a large language model, a foundation model, a vision language model, an image generation model, a text-to-image model, an audio generation model, and/or other generative models).

Training and/or tuning the machine-learned model can include obtaining a training instance. A set of training data can include a plurality of training instances divided between multiple datasets (e.g., a training dataset, a validation dataset, or testing dataset). A training instance can be labeled or unlabeled. The runtime inferences can form training instances when a model is trained using an evaluation of the model's performance on that runtime instance (e.g., online training/learning). Example data types for the training instance and various tasks associated therewith are described throughout the present disclosure.

Training and/or tuning can include processing, using one or more machine-learned models, the training instance to generate an output. The output can be directly obtained from the one or more machine-learned models or can be a downstream result of a chain of processing operations that includes an output of the one or more machine-learned models.

Training and/or tuning can include receiving an evaluation signal associated with the output. The evaluation signal can be obtained using a loss function. Various determinations of loss can be used, such as mean squared error, likelihood loss, cross entropy loss, hinge loss, contrastive loss, or various other loss functions. The evaluation signal can be computed using known ground-truth labels (e.g., supervised learning), predicted or estimated labels (e.g., semi- or self-supervised learning), or without labels (e.g., unsupervised learning). The evaluation signal can be a reward (e.g., for reinforcement learning). The reward can be computed using a machine-learned reward model configured to generate rewards based on output(s) received. The reward can be computed using feedback data describing human feedback on the output(s).

Training and/or tuning can include updating the machine-learned model using the evaluation signal. For example, values for parameters of the machine-learned model(s) can be learned, in some embodiments, using various training or learning techniques, such as, for example, backwards propagation. For example, the evaluation signal can be backpropagated from the output (or another source of the evaluation signal) through the machine-learned model(s) to update one or more parameters of the model(s) (e.g., based on a gradient of the evaluation signal with respect to the parameter value(s)). For example, system(s) containing one or more machine-learned models can be trained in an end-to-end manner. Gradient descent techniques can be used to iteratively update the parameters over a number of training iterations. In some implementations, performing backwards propagation of errors can include performing truncated backpropagation through time. Training and/or tuning can include implementing a number of generalization techniques (e.g., weight decays, dropouts, etc.) to improve the generalization capability of the models being trained.

In some implementations, the above training loop can be implemented for training a machine-learned model from an initialized state to a fully trained state (e.g., when the model exhibits a desired performance profile, such as based on accuracy, precision, recall, etc.).

In some implementations, the above training loop can be implemented for particular stages of a training procedure. For instance, in some implementations, the above training loop can be implemented for pre-training a machine-learned model. Pre-training can include, for instance, large-scale training over potentially noisy data to achieve a broad base of performance levels across a variety of tasks/data types. In some implementations, the above training loop can be implemented for fine-tuning a machine-learned model. Fine-tuning can include, for instance, smaller-scale training on higher-quality (e.g., labeled, curated, etc.) data. Fine-tuning can affect all or a portion of the parameters of a machine-learned model. For example, various portions of the machine-learned model can be “frozen” for certain training stages. For example, parameters associated with an embedding space can be “frozen” during fine-tuning (e.g., to retain information learned from a broader domain(s) than present in the fine-tuning dataset(s)). An example fine-tuning approach includes reinforcement learning. Reinforcement learning can be based on user feedback on model performance during use.

In some implementations, the computing system 100 may utilize one or more soft prompts for conditioning the one or more machine-learned models (120 and/or 140) for downstream tasks. The one or more soft prompts can include a set of tunable parameters that can be trained (or tuned) as the parameters of the one or more machine-learned models (120 and/or 140) are fixed. The one or more soft prompts 124 can be trained for a specific task and/or a specific set of tasks. Alternatively and/or additionally, the one or more soft prompts 124 may be trained to condition the one or more machine-learned models (120 and/or 140) to perform inferences for a particular individual, one or more entities, and/or one or more tasks such that the output is tailored for that particular individual, particular entities, and/or particular task. The one or more soft prompts 124 can be obtained and processed with one or more inputs by the one or more machine-learned models (120 and/or 140).

The one or more soft prompts can include a set of machine-learned weights. In particular, the one or more soft prompts can include weights that were trained to condition a generative model to generate model-generated content with one or more particular attributes. For example, the one or more soft prompts can be utilized by a user to generate content based on the fine-tuning. The one or more soft prompts can be extended to a plurality of tasks. For example, the computing system 100 may tune the set of parameters on a plurality of different content attributes and/or types. The one or more soft prompts may include a plurality of learned vector representations that may be model-readable.

A particular soft prompt can be obtained based on a particular task, individual, content type, etc. The particular soft prompt can include a set of learned parameters. The set of learned parameters can be processed with the generative model to generate the model-generated image.

The user computing system 102 and/or the server computing system 130 may store one or more soft prompts associated with the particular user and/or particular task. The soft prompt(s) can include a set of parameters. The user computing system 102 and/or the server computing system 130 may leverage the set of parameters of the soft prompt(s) and a generative model to generate a model-generated content item. In some implementations, the model-generated content item can be generated based on the set of parameters associated with the particular individual and/or task.

The utilization of a soft prompt (i.e., a set of parameters that can be processed with a generative model for downstream task conditioning) can reduce the computational cost for parameter tuning for object-specific content generation by reducing the parameters to be tuned. The set of parameters can be limited and may be adjusted while the parameters of the pre-trained generative model stay fixed. The set of parameters of the soft prompt can be utilized to condition the pre-trained generative model (e.g., the machine-learned image generation model and/or language model) for particular downstream tasks (e.g., response generation and/or image rendering).

In some implementations, the generative language model and/or one or more soft prompts (e.g., a set of machine-learned parameters that can be processed with the input by the generative language model) can be trained to generate content with particular attributes.

In some implementations, the server computing system 130 can include a prompt library. The prompt library can store a plurality of prompt templates (e.g., a plurality of hard prompt templates (e.g., text prompt templates)) and/or a plurality of soft prompts. The plurality of prompt templates can include hard prompt templates (e.g., text string data) that may be combined with the user input to generate a more detailed and complete prompt for the generative model to process. The templates can include text descriptive of the request. The templates may be object-specific, user-specific, and/or content-specific. The plurality of prompt templates may include few-shot examples.

The prompt library can store a plurality of soft prompts. The plurality of soft prompts may be associated with a plurality of different content attributes and/or a plurality of different individuals. The plurality of soft prompts can include learned parameters and/or learned weights that can be processed with the generative model to condition the generative model to generate content items with particular attributes. The plurality of soft prompts may have been tuned by freezing the parameters of a pre-trained generative model, while the parameters of the soft prompt are learned based on a particular task and/or user. The plurality of soft prompts can include a plurality of different soft prompts associated with a plurality of different users and/or a plurality of different sets of users.

The third party computing system 150 can include one or more processors 152 and a memory 154. The one or more processors 152 can be any suitable processing device (e.g., a processor core, a microprocessor, an ASIC, a FPGA, a controller, a microcontroller, etc.) and can be one processor or a plurality of processors that are operatively connected. The memory 154 can include one or more non-transitory computer-readable storage mediums, such as RAM, ROM, EEPROM, EPROM, flash memory devices, magnetic disks, etc., and combinations thereof. The memory 154 can store data 156 and instructions 158 which are executed by the processor 152 to cause the third party computing system 150 to perform operations. In some implementations, the third party computing system 150 includes or is otherwise implemented by one or more server computing devices.

The network 180 can be any type of communications network, such as a local area network (e.g., intranet), wide area network (e.g., Internet), or some combination thereof and can include any number of wired or wireless links. In general, communication over the network 180 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

The machine-learned models described in this specification may be used in a variety of tasks, applications, and/or use cases.

In some implementations, the input to the machine-learned model(s) of the present disclosure can be image data. The machine-learned model(s) can process the image data to generate an output. As an example, the machine-learned model(s) can process the image data to generate an image recognition output (e.g., a recognition of the image data, a latent embedding of the image data, an encoded representation of the image data, a hash of the image data, etc.). As another example, the machine-learned model(s) can process the image data to generate an image segmentation output. As another example, the machine-learned model(s) can process the image data to generate an image classification output. As another example, the machine-learned model(s) can process the image data to generate an image data modification output (e.g., an alteration of the image data, etc.). As another example, the machine-learned model(s) can process the image data to generate an encoded image data output (e.g., an encoded and/or compressed representation of the image data, etc.). As another example, the machine-learned model(s) can process the image data to generate an upscaled image data output. As another example, the machine-learned model(s) can process the image data to generate a prediction output.

In some implementations, the input to the machine-learned model(s) of the present disclosure can be text or natural language data. The machine-learned model(s) can process the text or natural language data to generate an output. As an example, the machine-learned model(s) can process the natural language data to generate a language encoding output. As another example, the machine-learned model(s) can process the text or natural language data to generate a latent text embedding output. As another example, the machine-learned model(s) can process the text or natural language data to generate a translation output. As another example, the machine-learned model(s) can process the text or natural language data to generate a classification output. As another example, the machine-learned model(s) can process the text or natural language data to generate a textual segmentation output. As another example, the machine-learned model(s) can process the text or natural language data to generate a semantic intent output. As another example, the machine-learned model(s) can process the text or natural language data to generate an upscaled text or natural language output (e.g., text or natural language data that is higher quality than the input text or natural language, etc.). As another example, the machine-learned model(s) can process the text or natural language data to generate a prediction output.

In some implementations, the input to the machine-learned model(s) of the present disclosure can be speech data. The machine-learned model(s) can process the speech data to generate an output. As an example, the machine-learned model(s) can process the speech data to generate a speech recognition output. As another example, the machine-learned model(s) can process the speech data to generate a speech translation output. As another example, the machine-learned model(s) can process the speech data to generate a latent embedding output. As another example, the machine-learned model(s) can process the speech data to generate an encoded speech output (e.g., an encoded and/or compressed representation of the speech data, etc.). As another example, the machine-learned model(s) can process the speech data to generate an upscaled speech output (e.g., speech data that is higher quality than the input speech data, etc.). As another example, the machine-learned model(s) can process the speech data to generate a textual representation output (e.g., a textual representation of the input speech data, etc.). As another example, the machine-learned model(s) can process the speech data to generate a prediction output.

In some implementations, the input to the machine-learned model(s) of the present disclosure can be sensor data. The machine-learned model(s) can process the sensor data to generate an output. As an example, the machine-learned model(s) can process the sensor data to generate a recognition output. As another example, the machine-learned model(s) can process the sensor data to generate a prediction output. As another example, the machine-learned model(s) can process the sensor data to generate a classification output. As another example, the machine-learned model(s) can process the sensor data to generate a segmentation output. As another example, the machine-learned model(s) can process the sensor data to generate a segmentation output. As another example, the machine-learned model(s) can process the sensor data to generate a visualization output. As another example, the machine-learned model(s) can process the sensor data to generate a diagnostic output. As another example, the machine-learned model(s) can process the sensor data to generate a detection output.

In some cases, the input includes visual data and the task is a computer vision task. In some cases, the input includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

In some implementations, the task can be a generative task, and the one or more machine-learned models (e.g., 120 and/or 140) can be configured to output content generated in view of one or more inputs. For instance, the inputs can be or otherwise represent data of one or more modalities that encodes context for generating additional content.

In some implementations, the task can be a text completion task. The machine-learned models can be configured to process the inputs that represent textual data and to generate the outputs that represent additional textual data that completes a textual sequence that includes the inputs. For instance, the machine-learned models can be configured to generate the outputs to complete a sentence, paragraph, or portion of text that follows from a portion of text represented by inputs.

In some implementations, the task can be an instruction following task. The machine-learned models can be configured to process the inputs that represent instructions to perform a function and to generate the outputs that advance a goal of satisfying the instruction function (e.g., at least a step of a multi-step procedure to perform the function). The outputs can represent data of the same or of a different modality as the inputs. For instance, the inputs can represent textual data (e.g., natural language instructions for a task to be performed) and the machine-learned models can process the inputs to generate the outputs that represent textual data responsive to the instructions (e.g., natural language responses, programming language responses, machine language responses, etc.). The inputs can represent image data (e.g., image-based instructions for a task to be performed, optionally accompanied by textual instructions) and the machine-learned models can process the inputs to generate the outputs that represent textual data responsive to the instructions (e.g., natural language responses, programming language responses, machine language responses, etc.). One or more outputs can be iteratively or recursively generated to sequentially process and accomplish steps toward accomplishing the requested functionality. For instance, an initial output can be executed by an external system or be processed by the machine-learned models to complete an initial step of performing a function. Multiple steps can be performed, with a final output being obtained that is responsive to the initial instructions.

In some implementations, the task can be a question answering task. The machine-learned models can be configured to process the inputs that represent a question to answer and to generate the outputs that advance a goal of returning an answer to the question (e.g., at least a step of a multi-step procedure to perform the function). The outputs can represent data of the same or of a different modality as the inputs. For instance, the inputs can represent textual data (e.g., natural language instructions for a task to be performed) and the machine-learned models can process the inputs to generate the outputs that represent textual data responsive to the question (e.g., natural language responses, programming language responses, machine language responses, etc.). The inputs can represent image data (e.g., image-based instructions for a task to be performed, optionally accompanied by textual instructions) and the machine-learned models can process the inputs to generate the outputs that represent textual data responsive to the question (e.g., natural language responses, programming language responses, machine language responses, etc.). One or more outputs can be iteratively or recursively generated to sequentially process and accomplish steps toward answering the question. For instance, an initial output can be executed by an external system or be processed by the machine-learned models to complete an initial step of obtaining an answer to the question (e.g., querying a database, performing a computation, executing a script, etc.). Multiple steps can be performed, with a final output being obtained that is responsive to the question.

In some implementations, the task can be an image generation task. The machine-learned models can be configured to process the inputs that represent context regarding a desired portion of image content. The context can include text data, image data, audio data, etc. Machine-learned models can be configured to generate the outputs that represent image data that depicts imagery related to the context. For instance, the machine-learned models can be configured to generate pixel data of an image. Values for channels associated with the pixels in the pixel data can be selected based on the context (e.g., based on a probability determined based on the context).

In some implementations, the task can be an audio generation task. Machine-learned models can be configured to process the inputs that represent context regarding a desired portion of audio content. The context can include text data, image data, audio data, etc. The machine-learned models can be configured to generate the outputs that represent audio data related to the context. For instance, the machine-learned models can be configured to generate waveform data in the form of an image (e.g., a spectrogram). Values for channels associated with pixels of the image can be selected based on the context. The machine-learned models can be configured to generate waveform data in the form of a sequence of discrete samples of a continuous waveform. Values of the sequence can be selected based on the context (e.g., based on a probability determined based on the context).

In some implementations, the task can be a data generation task. Machine-learned models can be configured to process the inputs that represent context regarding a desired portion of data (e.g., data from various data domains, such as sensor data, image data, multimodal data, statistical data, etc.). The desired data can be, for instance, synthetic data for training other machine-learned models. The context can include arbitrary data types. The machine-learned models can be configured to generate the outputs that represent data that aligns with the desired data. For instance, the machine-learned models can be configured to generate data values for populating a dataset. Values for the data objects can be selected based on the context (e.g., based on a probability determined based on the context).

The user computing system may include a number of applications (e.g., applications 1 through N). Each application may include its own respective machine learning library and machine-learned model(s). For example, each application can include a machine-learned model. Example applications include a text messaging application, an email application, a dictation application, a virtual keyboard application, a browser application, etc.

Each application can communicate with a number of other components of the computing device, such as, for example, one or more sensors, a context manager, a device state component, and/or additional components. In some implementations, each application can communicate with each device component using an API (e.g., a public API). In some implementations, the API used by each application is specific to that application.

The user computing system 102 can include a number of applications (e.g., applications 1 through N). Each application is in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer can include a number of machine-learned models. For example a respective machine-learned model (e.g., a model) can be provided for each application and managed by the central intelligence layer. In other implementations, two or more applications can share a single machine-learned model. For example, in some implementations, the central intelligence layer can provide a single model (e.g., a single model) for all of the applications. In some implementations, the central intelligence layer is included within or otherwise implemented by an operating system of the computing system 100.

The central intelligence layer can communicate with a central device data layer. The central device data layer can be a centralized repository of data for the computing system 100. The central device data layer may communicate with a number of other components of the computing device, such as, for example, one or more sensors, a context manager, a device state component, and/or additional components. In some implementations, the central device data layer can communicate with each device component using an API (e.g., a private API).

FIG. 11B depicts a block diagram of an example computing system 50 that performs visual query processing according to example embodiments of the present disclosure. In particular, the example computing system 50 can include one or more computing devices 52 that can be utilized to obtain, and/or generate, one or more datasets that can be processed by a sensor processing system 60 and/or an output determination system 80 to feedback to a user that can provide information on features in the one or more obtained datasets. The one or more datasets can include image data, text data, audio data, multimodal data, latent encoding data, etc. The one or more datasets may be obtained via one or more sensors associated with the one or more computing devices 52 (e.g., one or more sensors in the computing device 52). Additionally and/or alternatively, the one or more datasets can be stored data and/or retrieved data (e.g., data retrieved from a web resource). For example, images, text, and/or other content items may be interacted with by a user. The interacted with content items can then be utilized to generate one or more determinations.

The one or more computing devices 52 can obtain, and/or generate, one or more datasets based on image capture, sensor tracking, data storage retrieval, content download (e.g., downloading an image or other content item via the internet from a web resource), and/or via one or more other techniques. The one or more datasets can be processed with a sensor processing system 60. The sensor processing system 60 may perform one or more processing techniques using one or more machine-learned models, one or more search engines, and/or one or more other processing techniques. The one or more processing techniques can be performed in any combination and/or individually. The one or more processing techniques can be performed in series and/or in parallel. In particular, the one or more datasets can be processed with a context determination block 62, which may determine a context associated with one or more content items. The context determination block 62 may identify and/or process metadata, user profile data (e.g., preferences, user search history, user browsing history, user purchase history, and/or user input data), previous interaction data, global trend data, location data, time data, and/or other data to determine a particular context associated with the user. The context can be associated with an event, a determined trend, a particular action, a particular type of data, a particular environment, and/or another context associated with the user and/or the retrieved or obtained data.

The sensor processing system 60 may include an image preprocessing block 64. The image preprocessing block 64 may be utilized to adjust one or more values of an obtained and/or received image to prepare the image to be processed by one or more machine-learned models and/or one or more search engines 74. The image preprocessing block 64 may resize the image, adjust saturation values, adjust resolution, strip and/or add metadata, and/or perform one or more other operations.

In some implementations, the sensor processing system 60 can include one or more machine-learned models, which may include a detection model 66, a segmentation model 68, a classification model 70, an embedding model 72, and/or one or more other machine-learned models. For example, the sensor processing system 60 may include one or more detection models 66 that can be utilized to detect particular features in the processed dataset. In particular, one or more images can be processed with the one or more detection models 66 to generate one or more bounding boxes associated with detected features in the one or more images.

Additionally and/or alternatively, one or more segmentation models 68 can be utilized to segment one or more portions of the dataset from the one or more datasets. For example, the one or more segmentation models 68 may utilize one or more segmentation masks (e.g., one or more segmentation masks manually generated and/or generated based on the one or more bounding boxes) to segment a portion of an image, a portion of an audio file, and/or a portion of text. The segmentation may include isolating one or more detected objects and/or removing one or more detected objects from an image.

The one or more classification models 70 can be utilized to process image data, text data, audio data, latent encoding data, multimodal data, and/or other data to generate one or more classifications. The one or more classification models 70 can include one or more image classification models, one or more object classification models, one or more text classification models, one or more audio classification models, and/or one or more other classification models. The one or more classification models 70 can process data to determine one or more classifications.

In some implementations, data may be processed with one or more embedding models 72 to generate one or more embeddings. For example, one or more images can be processed with the one or more embedding models 72 to generate one or more image embeddings in an embedding space. The one or more image embeddings may be associated with one or more image features of the one or more images. In some implementations, the one or more embedding models 72 may be configured to process multimodal data to generate multimodal embeddings. The one or more embeddings can be utilized for classification, search, and/or learning embedding space distributions.

The sensor processing system 60 may include one or more search engines 74 that can be utilized to perform one or more searches. The one or more search engines 74 may crawl one or more databases (e.g., one or more local databases, one or more global databases, one or more private databases, one or more public databases, one or more specialized databases, and/or one or more general databases) to determine one or more search results. The one or more search engines 74 may perform feature matching, text based search, embedding based search (e.g., k-nearest neighbor search), metadata based search, multimodal search, web resource search, image search, text search, and/or application search.

Additionally and/or alternatively, the sensor processing system 60 may include one or more multimodal processing blocks 76, which can be utilized to aid in the processing of multimodal data. The one or more multimodal processing blocks 76 may include generating a multimodal query and/or a multimodal embedding to be processed by one or more machine-learned models and/or one or more search engines 74.

The output(s) of the sensor processing system 60 can then be processed with an output determination system 80 to determine one or more outputs to provide to a user. The output determination system 80 may include heuristic based determinations, machine-learned model based determinations, user selection based determinations, and/or context based determinations.

The output determination system 80 may determine how and/or where to provide the one or more search results in a search results interface 82. Additionally and/or alternatively, the output determination system 80 may determine how and/or where to provide the one or more machine-learned model outputs in a machine-learned model output interface 84. In some implementations, the one or more search results and/or the one or more machine-learned model outputs may be provided for display via one or more user interface elements. The one or more user interface elements may be overlayed over displayed data. For example, one or more detection indicators may be overlayed over detected objects in a viewfinder. The one or more user interface elements may be selectable to perform one or more additional searches and/or one or more additional machine-learned model processes. In some implementations, the user interface elements may be provided as specialized user interface elements for specific applications and/or may be provided uniformly across different applications. The one or more user interface elements can include pop-up displays, interface overlays, interface tiles and/or chips, carousel interfaces, audio feedback, animations, interactive widgets, and/or other user interface elements.

Additionally and/or alternatively, data associated with the output(s) of the sensor processing system 60 may be utilized to generate and/or provide an augmented-reality experience and/or a virtual-reality experience 86. For example, the one or more obtained datasets may be processed to generate one or more augmented-reality rendering assets and/or one or more virtual-reality rendering assets, which can then be utilized to provide an augmented-reality experience and/or a virtual-reality experience 86 to a user. The augmented-reality experience may render information associated with an environment into the respective environment. Alternatively and/or additionally, objects related to the processed dataset(s) may be rendered into the user environment and/or a virtual environment. Rendering dataset generation may include training one or more neural radiance field models to learn a three-dimensional representation for one or more objects.

In some implementations, one or more action prompts 88 may be determined based on the output(s) of the sensor processing system 60. For example, a search prompt, a purchase prompt, a generate prompt, a reservation prompt, a call prompt, a redirect prompt, and/or one or more other prompts may be determined to be associated with the output(s) of the sensor processing system 60. The one or more action prompts 88 may then be provided to the user via one or more selectable user interface elements. In response to a selection of the one or more selectable user interface elements, a respective action of the respective action prompt may be performed (e.g., a search may be performed, a purchase application programming interface may be utilized, and/or another application may be opened).

In some implementations, the one or more datasets and/or the output(s) of the sensor processing system 60 may be processed with one or more generative models 90 to generate a model-generated content item that can then be provided to a user. The generation may be prompted based on a user selection and/or may be automatically performed (e.g., automatically performed based on one or more conditions, which may be associated with a threshold amount of search results not being identified).

In some implementations, the one or more datasets and/or the output(s) of the sensor processing system 60 may be processed with one or more generative models 90 to generate a model-generated content item that can then be provided to a user. The generation may be prompted based on a user selection and/or may be automatically performed (e.g., automatically performed based on one or more conditions, which may be associated with a threshold amount of search results not being identified).

The one or more generative models 90 can include language models (e.g., large language models and/or vision language models), image generation models (e.g., text-to-image generation models and/or image augmentation models), audio generation models, video generation models, graph generation models, and/or other data generation models (e.g., other content generation models). The one or more generative models 90 can include one or more transformer models, one or more convolutional neural networks, one or more recurrent neural networks, one or more feedforward neural networks, one or more generative adversarial networks, one or more self-attention models, one or more embedding models, one or more encoders, one or more decoders, and/or one or more other models. In some implementations, the one or more generative models 90 can include one or more autoregressive models (e.g., a machine-learned model trained to generate predictive values based on previous behavior data) and/or one or more diffusion models (e.g., a machine-learned model trained to generate predicted data based on generating and processing distribution data associated with the input data).

The one or more generative models 90 can be trained to process input data and generate model-generated content items, which may include a plurality of predicted words, pixels, signals, and/or other data. The model-generated content items may include novel content items that are not the same as any pre-existing work. The one or more generative models 90 can leverage learned representations, sequences, and/or probability distributions to generate the content items, which may include phrases, storylines, settings, objects, characters, beats, lyrics, and/or other aspects that are not included in pre-existing content items.

The one or more generative models 90 may include a vision language model.

The vision language model can be trained, tuned, and/or configured to process image data and/or text data to generate a natural language output. The vision language model may leverage a pre-trained large language model (e.g., a large autoregressive language model) with one or more encoders (e.g., one or more image encoders and/or one or more text encoders) to provide detailed natural language outputs that emulate natural language composed by a human.

The vision language model may be utilized for zero-shot image classification, few shot image classification, image captioning, multimodal query distillation, multimodal question and answering, and/or may be tuned and/or trained for a plurality of different tasks. The vision language model can perform visual question answering, image caption generation, feature detection (e.g., content monitoring (e.g., for inappropriate content)), object detection, scene recognition, and/or other tasks.

The vision language model may leverage a pre-trained language model that may then be tuned for multimodality. Training and/or tuning of the vision language model can include image-text matching, masked-language modeling, multimodal fusing with cross attention, contrastive learning, prefix language model training, and/or other training techniques. For example, the vision language model may be trained to process an image to generate predicted text that is similar to ground truth text data (e.g., a ground truth caption for the image). In some implementations, the vision language model may be trained to replace masked tokens of a natural language template with textual tokens descriptive of features depicted in an input image. Alternatively and/or additionally, the training, tuning, and/or model inference may include multi-layer concatenation of visual and textual embedding features. In some implementations, the vision language model may be trained and/or tuned via jointly learning image embedding and text embedding generation, which may include training and/or tuning a system to map embeddings to a joint feature embedding space that maps text features and image features into a shared embedding space. The joint training may include image-text pair parallel embedding and/or may include triplet training. In some implementations, the images may be utilized and/or processed as prefixes to the language model.

The one or more generative models 90 may be stored on-device and/or may be stored on a server computing system. In some implementations, the one or more generative models 90 can perform on-device processing to determine suggested searches, suggested actions, and/or suggested prompts. The one or more generative models 90 may include one or more compact vision language models that may include less parameters than a vision language model stored and operated by the server computing system. The compact vision language model may be trained via distillation training. In some implementations, the visional language model may process the display data to generate suggestions. The display data can include a single image descriptive of a screenshot and/or may include image data, metadata, and/or other data descriptive of a period of time preceding the current displayed content (e.g., the applications, images, videos, messages, and/or other content viewed within the past 30 seconds). The user computing device may generate and store a rolling buffer window (e.g., 30 seconds) of data descriptive of content displayed during the buffer. Once the time has elapsed, the data may be deleted. The rolling buffer window data may be utilized to determine a context, which can be leveraged for query, content, action, and/or prompt suggestion.

In some implementations, the generative models 90 can include machine-learned sequence processing models. An example system can pass inputs to sequence processing models. Sequence processing models can include one or more machine-learned components. Sequence processing models can process the data from inputs to obtain an input sequence. Input sequence can include one or more input elements obtained from inputs. The sequence processing model can process the input sequence using prediction layers to generate an output sequence. The output sequence can include one or more output elements generated based on input sequence. The system can generate outputs based on output sequence.

Sequence processing models can include one or multiple machine-learned model components configured to ingest, generate, or otherwise reason over sequences of information. For example, some example sequence processing models in the text domain are referred to as “Large Language Models,” or LLMs. See, e.g., PaLM 2 Technical Report, Google, https://ai.google/static/documents/palm2techreport.pdf (n.d.). Other example sequence processing models can operate in other domains, such as image domains, see, e.g., Dosovitskiy et al., An Image is Worth 16×16 Words: Transformers for Image Recognition at Scale, arXiv:2010.11929v2 (Jun. 3, 2021), audio domains, see, e.g., Agostinelli et al., MusicLM: Generating Music From Text, arXiv:2301.11325v1 (Jan. 26, 2023), biochemical domains, see, e.g., Jumper et al., Highly accurate protein structure prediction with AlphaFold, 596 Nature 583 (Aug. 26, 2021), by way of example. Sequence processing models can process one or multiple types of data simultaneously. Sequence processing models can include relatively large models (e.g., more parameters, computationally expensive, etc.), relatively small models (e.g., fewer parameters, computationally lightweight, etc.), or both.

In general, sequence processing models can obtain an input sequence using data from inputs. For instance, input sequence can include a representation of data from inputs 2 in a format understood by sequence processing models. One or more machine-learned components of sequence processing models can ingest the data from inputs, parse the data into pieces compatible with the processing architectures of sequence processing models (e.g., via “tokenization”), and project the pieces into an input space associated with prediction layers (e.g., via “embedding”).

Sequence processing models can ingest the data from inputs and parse the data into a sequence of elements to obtain input sequence. For example, a portion of input data from inputs can be broken down into pieces that collectively represent the content of the portion of the input data. The pieces can provide the elements of the sequence.

In some implementations, processing the input data can include tokenization. For example, a tokenizer may process a given portion of an input source and output a series of tokens (e.g., corresponding to input elements) that represent the portion of the input source. Various approaches to tokenization can be used. For instance, textual input sources can be tokenized using a byte-pair encoding (BPE) technique. See, e.g., Kudo et al., SentencePiece: A simple and language independent subword tokenizer and detokenizer for Neural Text Processing, Proceedings of the 2018 Conference on Empirical Methods in Natural Language Processing (System Demonstrations), pages 66-71 (Oct. 31-Nov. 4, 2018), https://aclanthology.org/D18-2012.pdf. Image-based input sources can be tokenized by extracting and serializing patches from an image.

In general, arbitrary data types can be serialized and processed into an input sequence.

Prediction layers can predict one or more output elements based on the input elements. Prediction layers can include one or more machine-learned model architectures, such as one or more layers of learned parameters that manipulate and transform the inputs to extract higher-order meaning from, and relationships between, input elements. In this manner, for instance, example prediction layers can predict new output elements in view of the context provided by input sequence.

Prediction layers can evaluate associations between portions of input sequence and a particular output element. These associations can inform a prediction of the likelihood that a particular output follows the input context. For example, consider the textual snippet, “The carpenter's toolbox was small and heavy. It was full of ______.” Example prediction layers can identify that “It” refers back to “toolbox” by determining a relationship between the respective embeddings. Example prediction layers can also link “It” to the attributes of the toolbox, such as “small” and “heavy.” Based on these associations, prediction layers can, for instance, assign a higher probability to the word “nails” than to the word “sawdust.”

A transformer is an example architecture that can be used in prediction layers. See, e.g., Vaswani et al., Attention Is All You Need, arXiv:1706.03762v7 (Aug. 2, 2023). A transformer is an example of a machine-learned model architecture that uses an attention mechanism to compute associations between items within a context window. The context window can include a sequence that contains input sequence and potentially one or more output elements. A transformer block can include one or more attention layers and one or more post-attention layers (e.g., feedforward layers, such as a multi-layer perceptron).

Prediction layers can include other machine-learned model architectures in addition to or in lieu of transformer-based architectures. For example, recurrent neural networks (RNNs) and long short-term memory (LSTM) models can also be used, as well as convolutional neural networks (CNNs). In general, prediction layers can leverage various kinds of artificial neural networks that can understand or generate sequences of information.

Output sequence can include or otherwise represent the same or different data types as input sequence. For instance, input sequence can represent textual data, and output sequence can represent textual data. The input sequence can represent image, audio, or audiovisual data, and output sequence can represent textual data (e.g., describing the image, audio, or audiovisual data). It is to be understood that prediction layers, and any other interstitial model components of sequence processing models, can be configured to receive a variety of data types in input sequences and output a variety of data types in output sequences.

The output sequence can have various relationships to an input sequence. Output sequence can be a continuation of input sequence. The output sequence can be complementary to the input sequence. The output sequence can translate, transform, augment, or otherwise modify input sequence. The output sequence can answer, evaluate, confirm, or otherwise respond to input sequence. The output sequence can implement (or describe instructions for implementing) an instruction provided via an input sequence.

The output sequence can be generated autoregressively. For instance, for some applications, an output of one or more prediction layers can be passed through one or more output layers (e.g., softmax layer) to obtain a probability distribution over an output vocabulary (e.g., a textual or symbolic vocabulary) conditioned on a set of input elements in a context window. In this manner, for instance, the output sequence can be autoregressively generated by sampling a likely next output element, adding that element to the context window, and re-generating the probability distribution based on the updated context window, and sampling a likely next output element, and so forth.

The output sequence can also be generated non-autoregressively. For instance, multiple output elements of the output sequence can be predicted together without explicit sequential conditioning on each other. See, e.g., Saharia et al., Non-Autoregressive Machine Translation with Latent Alignments, arXiv:2004.07437v3 (Nov. 16, 2020).

The output sequence can include one or multiple portions or elements. In an example content generation configuration, the output sequence can include multiple elements corresponding to multiple portions of a generated output sequence (e.g., a textual sentence, values of a discretized waveform, computer code, etc.). In an example classification configuration, the output sequence can include a single element associated with a classification output. For instance, an output “vocabulary” can include a set of classes into which an input sequence is to be classified. For instance, a vision transformer block can pass latent state information to a multilayer perceptron that outputs a likely class value associated with an input image.

The output determination system 80 may process the one or more datasets and/or the output(s) of the sensor processing system 60 with a data augmentation block 92 to generate augmented data. For example, one or more images can be processed with the data augmentation block 92 to generate one or more augmented images. The data augmentation can include data correction, data cropping, the removal of one or more features, the addition of one or more features, a resolution adjustment, a lighting adjustment, a saturation adjustment, and/or other augmentation.

In some implementations, the one or more datasets and/or the output(s) of the sensor processing system 60 may be stored based on a data storage block 94 determination.

The output(s) of the output determination system 80 can then be provided to a user via one or more output components of the user computing device 52. For example, one or more user interface elements associated with the one or more outputs can be provided for display via a visual display of the user computing device 52.

The processes may be performed iteratively and/or continuously. One or more user inputs to the provided user interface elements may condition and/or affect successive processing loops.

The systems and methods disclosed herein can include an autonomous information seeking visual question answering framework. The systems and methods can leverage a large language model (LLM) to dynamically strategize the utilization of external tools and to investigate their outputs, thereby acquiring knowledge that can be utilized to provide answers to the posed questions. Responding to visual questions that necessitate external knowledge, such as “What event is commemorated by the building depicted in this image?”, can be a complex task. The task can present a combinatorial search space that demands a sequence of actions, including invoking application programming interfaces (APIs), analyzing the API tool call responses, and making informed decisions. Additionally and/or alternatively, the systems and methods can include conducting a user study to collect a variety of instances of human decision-making when faced with one or more particular tasks. The user behavior data (e.g., the collected user decision-making instances) can then be used to design a system that includes three components: a language model planner block (e.g., an LLM-powered planner) that dynamically determines which tool to use next, a language model reasoner block (e.g., an LLM-powered reasoner) that analyzes and extracts key information from the tool outputs, and a working memory component that retains the acquired information throughout the process. The collected user behavior data can serve as a guide for the system in two key ways. First, the systems and methods may generate a transition graph by analyzing the sequence of decisions made by users. The graph can delineate distinct states and can confine the set of actions available at each state. Second, the systems and methods can use examples of user decision-making to provide the LLM-powered planner and reasoner with relevant contextual instances, enhancing their capacity to make informed decisions.

Large language models (LLMs) (e.g., GPT3 (Brown et al., “Language models are few-shot learners,” ADVANCES IN NEURAL INFORMATION PROCESSING SYSTEMS, 33:1877-1901, 2020.), LaMDA (Kulshreshtha et al., “Towards a human-like open-domain chatbot,” ARXIV PREPRINT, 2020.), PALM (Chowdhery et al., “Palm: Scaling language modeling with pathways,” ARXIV PREPRINT, 2022.), BLOOM (Scao et al., “BLOOM: A 176b-parameter open-access multilingual language model,” CORR, abs/2211.05100, 2022.), and LLAMA (Touvron et al., “Llama: Open and efficient foundation language models,” ARXIV PREPRINT, 2023.) may have the capacity to memorize and utilize a significant amount of world knowledge. The language models can demonstrate emerging abilities like in-context learning, code generation, and common sense reasoning. Additionally and/or alternatively, language models can be adapted to handle multi-modal inputs and outputs involving both vision and language. In particular, visual language models (VLMs) can be utilized for image captioning, visual question answering, and open vocabulary recognition.

While LLMs excel beyond human capabilities in tasks involving textual information retrieval, the existing VLMs can perform inadequately on datasets designed for visual information seeking. Many of the visual questions in the datasets can be designed in such a way that they pose a challenge even for humans, often requiring the assistance of various APIs and web search to obtain the answer. Examples of such questions can include “where is this church located?”, “what species of butterfly is this?”, or “what is the brand of this dress?”.

Existing vision-language models (VLMs) can struggle to answer such questions for several reasons. Firstly, they may not be trained with objectives that encourage them to discern fine-grained categories and details within images. Secondly, they may utilize a relatively smaller language model compared to state-of-the-art Large Language Models (LLMs), which can constrain their reasoning capabilities. Lastly, they may not compare the query image against a substantial corpus of images associated with varying metadata, unlike systems that employ image search techniques.

To overcome these challenges, the systems and methods disclosed herein may obtain state-of-the-art results on visual information seeking tasks by integrating LLMs with three types of tools: (i) computer vision tools such as object detection, OCR, image captioning models, and VQA models, which aid in extracting visual information from the image, (ii) a web search tool that assists in retrieving open world knowledge and facts, and (iii) an image search tool that enables us to glean relevant information from metadata associated with visually similar images. The systems and methods may include an LLM agent that uses the tools via tree-search decision making. The systems and methods may utilize an LLM-powered planner to dynamically determine which tool to use at each step and what query to send to it. Additionally and/or alternatively, the systems and methods may employ an LLM-powered reasoner that scrutinizes the output returned by the tools and extracts the crucial information from them. To retain the information throughout the process, the systems and methods can use a working memory component. FIG. 4 can convey an example information seeking process performed by an example implementation.

In some implementations, the systems and methods can employ a two-stage strategy, namely plan and execute. Initially, the LLM can break down a question into a plan, typically represented as a structured program or a sequence of instructions. Following the breakdown, the necessary APIs can be activated to collect the required information. However, the systems and methods may struggle in more complex real-world situations. In such cases, a comprehensive plan may not be inferred merely from the initial question. Instead, the systems and methods may necessitate dynamic modifications based on real-time feedback.

To address the difficulty, the systems and methods disclosed herein can include a dynamic decision-making capability. Answering visual information seeking questions can be a highly complex task, requiring the planner to take multiple steps. At each of the steps, the planner may determine which API to call and what query to send. The systems and methods disclosed herein can opt for a dynamic approach as the API call outputs may be unpredictable. In particular, the systems and methods may determine decisions at each step based on the information acquired from previous API calls, enhancing the adaptability and effectiveness of the method.

In some implementations, a user study can be performed to gather a wide range of instances of human decision-making when using APIs to answer questions related to visual information seeking. From the user data, a structured framework can be utilized to direct the Large Language Model (LLM) to use the examples for making informed decisions regarding API selection and query formulation. The collected user behavior can inform the system in two ways. First, by analyzing the sequence of user decisions, the systems and methods can construct a transition graph. The graph may delineate distinct states and may constrain the set of actions available at each state. Second, the systems and methods can use the examples of user decision-making to guide the planner and reasoner with pertinent contextual instances. The contextual examples can contribute to improving the performance and effectiveness of the system.

In some implementations, the systems and methods can include a visual question answering framework that leverages a large language model (LLM) to dynamically strategize the utilization of external tools and to investigate their outputs, thereby acquiring the necessary knowledge needed to provide answers to the posed questions. Additionally and/or alternatively, the systems and methods can leverage the human decision-making data collected from a user study to develop a structured framework. The framework can guide the Large Language Model (LLM) to utilize examples of human decision-making in making informed choices concerning API selection and query construction.

In some implementations, the systems and methods can employ a dynamic decision-making strategy designed to respond to visual information seeking queries. For example, the systems and methods can include three primary components. First, the system can include a planner [symbol] , whose responsibility is to determine the subsequent action, including the appropriate API call and the query to be processed. Second, the system can have a working memory [symbol] that retains information about the results obtained from API executions. Lastly, the system can have a reasoner [symbol] , whose role is to process the outputs from the API calls. The reasoner can determine whether the obtained information is sufficient to produce the final response, or if additional data retrieval is determined to be needed.

Considering the potential intricacy of the task, a user study can be conducted to gather a broad range of examples of human decision-making process, when using tools to respond to visual information seeking queries. A structured framework for decision-making can then be utilized based on the user behavior data. The systems and methods can utilize the data collected from this study to construct a transition graph [symbol] shown in FIG. 5, which outlines all the possible actions at each given state. Additionally and/or alternatively, the systems and methods can employ real-life decision-making examples ε (i.e., users choose which tool at different states) to guide the planner in choosing the appropriate action at each stage of the process.

The Algorithm 1 below can present the operations of the planner [symbol] . The planner can undertake a series of steps each time a decision is required regarding which tool to employ and what query to send to the tool. Firstly, based on the present state, the planner can provide a range of potential subsequent actions Aₛ. The potential action space Aₛ may be large, making the search space in-tractable. To address this issue, the planner can refer to the human decisions from the transition graph [symbol] to eliminate irrelevant actions. The planner may exclude the actions that have already been taken before and are stored in the working memory [symbol] . The procedure can include Aₛ←φ(state, [symbol] , [symbol] ).

Algorithm 1 Planner [symbol] (state, [symbol] , [symbol] , [symbol] ):
1: Aₛ ← φ (state, [symbol] , [symbol] ) [symbol] Get the list of feasible actions Aₛ given the current state from
a transition graph and the information in the working memory.
2: *ₛ ← ( [symbol] , Aₛ) [symbol] Get a list of in-context examples related to actions Aₛ.
3: pₛ ← ( [symbol] ₛ, [symbol] ) [symbol] Build a prompt based on the in-context examples [symbol] ₛ
and the current working memory [symbol] .
4: tₛ, qₛ < LLM (pₛ) [symbol] Decide the next tool tₛ to use and the query qₛ
to pass by feeding the prompt pₛ to LLM.

Next, the systems and methods can collect a set of relevant in-context examples εₛ that are assembled from the decisions previously made by humans during the user study relevant to actions Aₛ, that is εₛ←θ(ε, Aₛ). With the gathered in-context examples εₛ and the working memory [symbol] that holds data collected from past tool interactions, the planner can formulate a prompt, denoted by pₛ←ψ(εₛ, [symbol] ). The prompt pₛ can then be sent to the LLM which returns a structured answer, determining the next tool tₛ to be activated and the query qₛ to be dispatched to the data processing tool. The action can be denoted by tₛ, qₛ←LLM(pₛ). The design can allow the planner to be invoked multiple times throughout the process, thereby facilitating dynamic decision-making that gradually leads to answering the input query.

The Algorithm 2 can be descriptive of an overall decision-making workflow of automatic visual information seeking. The entire process can repeat until a satisfactory answer is produced. Initially, the working memory may be populated with the input visual question I, and the initial state can be set to START. At each iteration, the system can first invoke the planner [symbol] to determine the next tool and the query to employ, as outlined in Algorithm 1. Subsequently, the selected external tool can execute and can deliver the output oₛ. The output from the tools can be quite diverse, ranging from a list of identified objects, to a collection of similar images with their captions, to snippets of search results or knowledge graph entities.

Algorithm 2 AVIS Decision Making Workflow:
1: [symbol] ← {input}, state ← START
2: tₛ, qₛ & [symbol] (state, [symbol] , [symbol] , [symbol] ) [symbol] Call the planner [symbol] to decide the
next tool to use tₛ and the query to pass to it qₛ.
3: oₛ ← Exec (tₛ, qₛ) [symbol] Call tool tₛ with query qₛ and get output oₛ.
4: ôₛ ← [symbol] (oₛ, [symbol] ) [symbol] Process the output and extract the
key info ôₛ using the reasoner [symbol] .
5: [symbol] . add (ôₛ) [symbol] Update the working memory.
6: switch ôₛ do.
7: case ôₛ is not informative.
8: goto (2) [symbol] Go to line 2 to make decision at
the same state, excluding tₛ.
9: case ôₛ has useful information.
10: state ← tₛ [symbol] Update state.
11: goto (2) [symbol] Go to line 2 to make decision for the next state.
12: case ôₛ is ready as a final answer.
13: ans ← ôₛ [symbol] Output answer.

Therefore, the system can employ a reasoner [symbol] to analyze the output oₛ, can extract the useful information, and can decide into which category the tool output falls: informative, uninformative, or final answer. The method can utilize the LLM with appropriate prompting and in-context examples to perform the reasoning. If the reasoner concludes that the model is ready to provide an answer, the model can generate and output the final response, thus concluding the task. If the model determines that the tool output is uninformative, the machine-learned model may revert back to the planner to select another action based on the current state. If the language model finds the tool output to be useful, the machine-learned model may modify the state and transfer control back to the planner to make a new decision at the new state.

To illustrate with a tangible example, the systems and methods can refer to the output that the model would receive as depicted in FIG. 6(c). There can be several entities within the answer. The role of the reasoner may be twofold: to determine which entity is pertinent for responding to the question and to assess whether the model has obtained the necessary information to transition to the next state.

In some implementations, the approach, which employs dynamic decision-making coupled with backtracking, can differ from previous methods that follow a plan-then-execute paradigm. The system can be structured to make decisions grounded to the results of current executions and to conduct iterative searches for tool combinations. The process may eventually yield an effective strategy to accomplish the task.

To respond effectively to visual queries that necessitate in-depth information retrieval, the systems and methods can equip a system with a comprehensive suite of tools. In particular, the suite of tools may include an image captioning model, a visual question answering model, an object detection model, an image search engine, a web search engine, an optical character recognition model, a language model tuned (and/or conditioned) for short question-and-answer tasks, and/or other data processing tools.

The image captioning model may employ a captioning model (e.g., the PALI 17B (Chern et al., “TPU-KNN: K nearest neighbor search at peak flop/s,” CoRR, abs/2206.14286, 2022.)), which obtains state-of-the-art results for image captioning. The tool may have the capability to generate captions for either the entire image or for a cropped image corresponding to the bounding box of a detected object.

The visual question answering model may utilize a VQA model (e.g., the PALI 17B), which may have been fine-tuned on a visual question-and-answer specific dataset (e.g., the VQA-v2 dataset (Goyal et al., “Making the V in VQA matter: Elevating the role of image understanding in visual question answering,” IN 2017 IEEE CONFERENCE ON COMPUTER VISION AND PATTERN RECOGNITION, CVPR 2017, Honolulu, HI, USA, Jul. 21-26, 2017, pages 6325-6334, IEEE COMPUTER SOCIETY, 2017.)). The tool can intake an image and a question as inputs and can provide a text-based answer as the output.

The object detection model may use an object detector trained on a super-set of Open Images dataset (Kuznetsova et al., “The open images dataset v4: Unified image classification, object detection, and visual relationship detection at scale,” IJCV, 2020.) categories that may be provided by a visual search application programming interface (e.g., the Google Lens API (“Google lens,” Web interface available at https://images.google.com.)). The systems and methods may use a high confidence threshold to only keep the top-ranked detected boxes for the input image.

The image search engine may utilize a reverse image search system (e.g., Google Image Search) to obtain a broad range of information related to the image crop of a detected box (e.g., as provided in Google Lens API). The information may encompass various details, such as knowledge graph entities, titles of associated products, and captions of analogous or identical images. The availability of these details can vary based on the image crop input provided to the reverse image search system (e.g., Google Image Search). The planner may consider the utilization of each piece of information as a separate action. The consideration may be due to the fact that each information set may contain hundreds of tokens that necessitate complex processing and reasoning.

The optical character recognition model may process images with text to determine the depicted text. For example, in some implementations, images may include textual content such as street names or logos. To detect and utilize this text, the systems and methods may leverage the Optical Character Recognition (OCR) feature available in an image processing application (e.g., the Google Lens API).

The web search engine may enable the system to acquire up-to-date world knowledge and retrieve relevant documents on any topic of interest. For example, the systems and methods may employ a web search platform (e.g., the Google Web Search API). The web search engine may process a text-based query as input and may produce the following outputs: (i) related document links and snippets, (ii) in certain instances, a knowledge panel providing a direct answer to the query, and (iii) a plurality of questions (e.g., five questions) that are related to the input query. If a knowledge panel is available, the system may parse the knowledge panel into a sentence or a few sentences that summarize the knowledge panel information.

In some implementations, the systems and methods may incorporate a Language Model (LLM) powered question-answering component as another tool. The tool may process a query in text form and may generate an answer also in text form. The use of the LLM here as a question-answering tool may be distinct from language model's role in the planner or reasoner as outlined in Alg. 1 and Alg. 2.

Many of the visual questions in existing datasets may ask for fine-grained answers, which poses a challenge even for humans, often requiring the assistance of various APIs and web searches for answers. In order to gather insights into human decision-making process, then systems and methods may include performing a user study. For example, a user study may be performed to understand how humans utilize external tools to answer visual queries that involve seeking information.

The user may be provided with an identical set of tools as the tools accessible to the machine-learned model via an API. The users may be presented with the input image and question, along with image crops for each detected object. Additionally and/or alternatively, tools such as an image captioning model, an object detection model, a visual question answering model, a web search engine, and/or an image search engine may be made available to the user. Based on the information obtained through image search for each cropped image, the user may be offered one or multiple buttons associated with each box. The user interface elements (e.g., the buttons) may provide the user with the ability to access diverse information pertaining to the image crop of the box. The diverse information may include details such as corresponding knowledge graph entities, captions of similar images, titles of associated related products, and captions of identical images. An example set of tools and APIs are depicted in FIG. 6(b).

When the user initiates an action, such as clicking on a button or submitting a query to web search, the image captioning model, the object detection model, the image search engine, and/or the visual question answering model, the corresponding tool may be invoked, and the resulting output may be displayed to the user. The system may record the sequence of actions taken by the user and the outputs that they receive at each step. For instance, in FIG. 6, an example of how a user performs four actions to answer the question is displayed: i) display entities in box 2, ii) show the caption of similar images to box 2, iii) conduct a search for “In what year was Harley-Davidson XA built?”, and iv) utilize PALM using the combination of the search output and the question “In what year was Harley-Davidson XA built?”. When the user is prepared to proceed to the next question, the user may click on either of the two buttons: “Success! Found the Answer!” or “Couldn't Find the Answer.” Subsequently, a new visual question may be presented to them.

The collected user behavior may serve as a guide for the system in two key ways. Firstly, the system may construct a transition graph by analyzing the sequence of decisions made by users. The graph can define distinct states and may restrict the available set of actions at each state. For example, at the START state, the system may take one of these three actions: image captioning, visual question answering, or object detection. FIG. 5 can illustrate the transition graph that has been constructed based on the decision-making process of the users. Secondly, the systems and methods may utilize the examples of user decision-making to guide the planner and reasoner with relevant contextual instances. The in-context examples can aid in enhancing the performance and effectiveness of the system.

The user study may involve ten or more participants who collectively answered a total of 644 visual questions. During the study, the system may present users with visual questions that were randomly selected from one or more datasets. The approach can allow the system to provide the participants with a varied and diverse set of visual questions to assess and respond to.

The systems and methods disclosed herein can include an approach that equips the Large Language Models (LLM) with the ability to use a variety of tools for answering knowledge-intensive visual questions. The methodology, anchored in human decision-making data collected from a user study, can employ a structured framework that uses an LLM-powered planner to dynamically decide on tool selection and query formation. An LLM-powered reasoner can be tasked with processing and extracting key information from the output of the selected tool. The systems and methods may iteratively employ the planner and reasoner to leverage different tools until all necessary information required to answer the visual question is amassed.

Experiments can be leveraged to evaluate AVIS on two visual question answering datasets: i) OK-VQA (Marino et al., “OK-VQA: A visual question answering benchmark requiring external knowledge,” In IEEE Conference on Computer Vision and Pattern Recognition, CVPR, pages 3195-3204 (2019).), which may rely on common-sense knowledge not observed in given image; and ii) Infoseek_{wikidata} (Chen et al., “Can Pre-trained Vision and Language Models Answer Visual Information-Seeking Questions?,” arXiv (Feb. 23, 2022), https://arxiv.org/abs/2302.11713.), which further necessitates more fine-grained information that cannot be covered by common sense knowledge.

The experiments can follow the decision-making workflow in Alg. 2 to implement AVIS to solve visual questions. For the Planner, the system may write the basic instructions for describing each tool, and keep a pool of real user behavior when they select each tool, which may be collected in the user study. At each step s, the system may prepare the prompt based on the feasible action lists [symbol] ₛ. For the Reasoner, the system may write the prompt for all APIs that return a long list of results, including Object Detection, Product Detection, Web Image Search and Web Text Search, that guides reasoner to extract the relevant information. The system may design the reasoner in a way such that the “uninformative” answers can be detected. In order to support this, the system may manually prepare several bad examples that do not provide any useful information, pass it to the reasoner as a part of the prompt.

The system may use the frozen PALM 540B language model (Chowdhery et al. “PaLM: Scaling Language Modeling with Pathways,” arXiv (Apr. 5, 2022), https://arxiv.org/abs/2204.02311.) for both the planner and the reasoner, with deterministic generation ensured by setting the temperature parameter to zero. The experiment may use 10 examples as in-context prompts for each dataset, and report the VQA accuracy (Goyal et al., “Making the Vin VQA matter: Elevating the role of image understanding in visual question answering,” In 2017 IEEE Conference on Computer Vision and Pattern Recognition, CVPR 2017, pages 6325-6334 (July 2017).) as the evaluation metric.

The experiments can utilize one or more baselines. AVIS can have the ability to dynamically determine the relevant tools according to different states. To show that the design choice is useful, the experiments may add a number of baselines that do not include a LLM-planner for dynamic decision making. Instead, they may follow a pre-determined sequence to call a list of tools. The experiments may propose the following baselines: baseline-PALM w/ PALI* (which integrates the captions generated by PALI and the visual answers from PALI VQA, PALI* denotes the combination of both VQA and captioning tool), baseline-PALM w/ (PALI*+Object) (which in addition calls the object detection tool, and then integrates all object data, including products and text detected by OCR), baseline-PALM w/ (PALI*+Object+Search) (a model which first selects a relevant object with the help of PALM, then sequentially executes the image search and Google search with the object name). The experiments may then call PALM again to answer the question. For each of the three baselines, the system may prepare a few-shot Chain-Of-Thought (COT) prompting (Wei et al., “Chain-of-Thought Prompting Elicits Reasoning in Large Language Models,” arXiv (Jan. 28, 2022), https://arxiv.org/abs/2201.11903.), in which the COT prompt guides the model to explain why predictions are made based on the provided information. The baselines can utilize a set of tools in a fixed order, without the capacity for dynamic decision making.

The experiments may evaluate the usefulness of each tool group (i.e., PALI*, Object, and Search) through an ablation study. The experiments can involve removing each tool group from our framework individually, and assessing the impact on performance.

| | Unseen | Unseen |
|---|---|---|
| Model | Entity | Question |
| PALM (Q-only, few-shot) | 3.7 | 5.1 |
| OFA (fine-tune) | 9.7 | 14.8 |
| PALI (VQA, zero-shot) | 1.8 | 2.2 |
| PALI (fine-tune) | 16 | 20.7 |
| PALM w/ CLIP (few-shot + external knowledge) | 21.9 | 18.6 |
| FiD w/ CLIP (fine-tune + external knowledge) | 20.7 | 18.1 |
| (—baselines without dynamic decision making, | | |
| sequentially execute the tools—) | | |
| baseline-PALM w/ | | |
| (PALI*, few-shot) | 12.8 | 14.9 |
| baseline-PALM w/ (PALI* + Object, few-shot) | 31.3 | 36.1 |
| baseline-PALM w/ (PALI* + Object + Search, | 36.1 | 38.2 |
| few-shot) | | |
| AVIS (ours, few-shot) | 50.7 | 56.4 |
| w/o PALI* | 47.9 | 54.2 |
| w/o Object | 41.2 | 48.4 |
| w/o Search | 42.5 | 49.6 |

Table 1 can include visual question answering results (accuracy) on Infoseek_{Wikidata}. The first four rows can be results from their paper that do not use external knowledge, and the next two can be from their paper that use CLIP as knowledge source. The tool PALI* denotes the frozen multi-task PALI-17B model for both visual question answering and image captioning. Object means object detection, and search means image and text search.

Table 1 can present the results of AVIS and other baselines on the Infoseek_{wikidata} dataset. Infoseek_{wikidata} can be a challenging dataset that requires identifying highly specific entities. Even robust visual-language models, such as OFA (Lu et al., “Unified-io: A unified model for vision, language, and multi-modal tasks,” CoRR, abs/2206.08916, (2022).) and PALI (Chen et al. “PaLI: A Jointly-Scaled Multilingual Language-Image Model,” arXiv (Sep. 25, 2022), https://arxiv.org/abs/2209.06794.), can fail to yield high accuracy when fine-tuned on this dataset. However, AVIS, without fine-tuning and by leveraging a complete set of tools guided by 10 in-context examples, can achieve the accuracy of 50.7 and 56.4 on the unseen entity and question splits, respectively. The AVIS system can significantly outperform the fine-tuned results of PALI-17B, which are 16.0 and 20.7, as well as the PALM model augmented with CLIP knowledge, which are 21.9 and 18.6, respectively.

Table 1 can illustrate that improvements may not be solely due to the additional information provided by the external tools, but due to the dynamic decision-making pipeline. The experiments can compare the results of AVIS with the three baselines that conduct sequential execution. While these baselines do improve the performance, our AVIS framework outperforms the best baseline model by up to 17.3 accuracy. Note that AVIS and the baselines can use exactly the same set of tools. The considerable performance gap can convey the clear advantage of dynamic decision-making design. Furthermore, the system may show the importance of each tool in the last block of Table 1. Removal of any of the tools can degrade the overall accuracy. Among the three tool groups, Object and Search can be more important than PALI, as they provide more fine-grained information crucial for the Infoseek dataset.

| | | Accuracy |
|---|---|---|
| | Model | (%) |
| Supervised | KRISP | 38.4 |
| | KAT | 54.4 |
| | ReVIVE | 58 |
| | REVEAL | 59.1 |
| | PALI (OK-VQA, finetune) | 64.5 |
| Zero-shot | PALI (VQA, zero-shot) | 41.6 |
| | PICa-Full | 48 |
| | Flamingo (zero-shot) | 50.6 |
| | BLIP-2 | 45.9 |
| | ViperGPT (one-shot) | 51.9 |
| | Flamingo (few-shot) | 57.8 |
| | (baselines without | |
| | dynamic decision making, | |
| | sequentially executing the tools) | |
| | baseline-PALM w/ (PALI*) | 44.3 |
| Few-shot | baseline-PALM w/ (PALI* + Object) | 38.2 |
| | baseline-PALM w/ | 47.9 |
| | (PALI* + Object + Search) | |
| | AVIS | 60.2 |
| | w/o PALI* | 47.1 |
| | w/o Object | 58.3 |
| | w/o Search | 55 |

Table 2 can include visual question answering results (accuracy) on OK-VQA. The tool PALI* denotes the frozen multi-task PALI-17B model for both visual question answering and image captioning. Object can denote object detection, and search can denote image and text search.

The OK-VQA experiments are depicted in Table 2. AVIS with few-shot in-context examples can achieve an accuracy of 60.2, higher than most of the existing methods tailored for the dataset, including KAT (Gui et al., “KAT: A Knowledge Augmented Transformer for Vision-and-Language,” arXiv (Dec. 16, 2021), https://arxiv.org/abs/2112.08614.), ReVIVE (Lin et al., “REVIVE: Regional Visual Representation Matters in Knowledge-Based Visual Question Answering,” arXiv (Jun. 2, 2022), https://arxiv.org/abs/2206.01201.), and REVEAL (Hu et al., “REVEAL: Retrieval-Augmented Visual-Language Pre-Training with Multi-Source Multimodal Knowledge Memory,” arXiv (Dec. 10, 2022), https://arxiv.org/abs/2212.05221.). AVIS can achieve lower but comparable performance compared to PALI model fine-tuned on OK-VQA. This difference, compared to Infoseek, may be attributed to the fact that most QA examples in OK-VQA rely more on commonsense knowledge than on fine-grained knowledge. Therefore, it may be feasible to encode such generic knowledge in the model parameters and requires less external knowledge. PALI zero-shot VQA model itself can achieve 41.6 accuracy, which can be significantly higher than in Infoseek, which supports this hypothesis. Table 2 can show that the object detection is less crucial as a tool on this data set, compared to PALI captioning and VQA.

One of the features of AVIS can be the ability to dynamically make decisions instead of executing a fixed sequence. FIG. 5 can present three examples of AVIS's dynamic planning and reasoning process. They can demonstrate the flexibility of AVIS to use different tools at various stages. The reasoner design can enable AVIS to identify irrelevant information, backtrack to a previous state, and repeat the search. For instance, in the second example concerning the taxonomy of fungi, AVIS may make an incorrect decision by selecting a leaf object. However, the reasoner can identify that this is not relevant to the question, prompting AVIS to plan again. This time, the system may successfully select the object related to false turkey-tail fungi, leading to the correct answer, Stereum.

The training datasets can include visual question and answer datasets. The training examples can include an image, a question about the question, and an answer to the question.

The systems and methods can decompose questions into a visual sub-question and a knowledge sub-question.

The systems and methods may be designed and/or utilized for visual question answering and/or other reasoning tasks.

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

1. A computing system for visual information seeking, the system comprising:
one or more processors; and
one or more non-transitory computer-readable media that collectively store instructions that, when executed by the one or more processors, cause the computing system to perform operations, the operations comprising:
obtaining input data, wherein the input data comprises image data and text data, wherein the text data comprises a query associated with the image data;
processing the input data with a machine-learned model to generate first planning data, wherein the first planning data is descriptive of instructions to provide the input data to a first data processing tool;
transmitting, based on the first planning data, the input data to the first data processing tool to retrieve first output data;
processing the input data and the first output data with the machine-learned model to generate second planning data, wherein the second planning data is descriptive of instructions to transmit data to a second data processing tool;
transmitting, based on the second planning data, data to the second data processing tool to retrieve second output data; and
processing the input data and the second output data with the machine-learned model to generate response data, wherein the response data is descriptive of a response to the query.

2. The system of claim 1, wherein the first data processing tool comprises an object detection model.

3. The system of claim 2, wherein the first output data comprises one or more bounding boxes associated with one or more objects in the image data.

4. The system of claim 2, wherein the first output data comprises one or more segmented portions of one or more images of the image data and caption data associated with the one or more segmented portions.

5. The system of claim 4, wherein the caption data is descriptive of an object classification associated with one or more objects detected in the one or more segmented portions of one or more images.

6. The system of claim 1, wherein the second data processing tool comprises a search engine.

7. The system of claim 6, wherein the second planning data comprises a model-generated query, and wherein the model-generated query is transmitted to the second data processing tool to retrieve the second output data.

8. The system of claim 7, wherein the model-generated query is generated based on the input data and the first output data, wherein the model-generated query is descriptive of the query of the input data modified based on the first output data.

9. The system of claim 1, wherein the response data comprises a natural language text string that is responsive to the query of the input data.

10. The system of claim 1, wherein the operations further comprise:
processing the input data and the second output data with the machine-learned model to generate third planning data, wherein the third planning data is descriptive of instructions to transmit data to a third data processing tool;
transmitting, based on the third planning data, data to the third data processing tool to retrieve third output data; and
processing the input data and the third output data with the machine-learned model to generate the response data.

11. A computer-implemented method for responding to visual prompts, the method comprising:
obtaining, by a computing system comprising one or more processors, input data, wherein the input data comprises image data and text data, wherein the text data comprises a query associated with the image data;
processing, by the computing system, the input data with a machine-learned model to generate first planning data, wherein the first planning data is descriptive of instructions to provide the image data to a first data processing tool;
providing, by the computing system, the image data to the first data processing tool to receive first output data, wherein the first output data is generated with the first data processing tool based on the image data;
processing, by the computing system, the first output data with the machine-learned model to generate second planning data, wherein the second planning data is descriptive of instructions to provide a particular portion of the image data to a second data processing tool;
providing, by the computing system, the particular portion of the image data to the second data processing tool to receive second output data, wherein the second output data is generated with the second data processing tool based on the particular portion of the image data; and
processing, by the computing system, the text data and the second output data with the machine-learned model to generate response data, wherein the response data is descriptive of a response to the query.

12. The method of claim 11, wherein the machine-learned model was conditioned on a training dataset comprising a plurality of training examples, wherein each training example of the plurality of training examples comprises a training input, a training output, and a training rationale, wherein the training rationale is descriptive of a sequence of processing instances and tool calls for determining the output data.

13. The method of claim 11, wherein the machine-learned model was conditioned on a training dataset comprising sequence data, wherein sequence data is descriptive of a sequence of actions for generating a training response in response to obtaining a particular type of input.

14. The method of claim 11, wherein the machine-learned model was conditioned on human input data descriptive of actions a human selected as being particular actions to perform when a particular input type is received.

15. The method of claim 14, wherein the human input data was obtained via a user interface that provides a plurality of selectable options for a user.

16. The method of claim 15, wherein the plurality of selectable options comprise a plurality of external tools to call and a final output option.

17. One or more non-transitory computer-readable media that collectively store instructions that, when executed by one or more computing devices, cause the one or more computing devices to perform operations, the operations comprising:
obtaining input data, wherein the input data comprises image data and text data, wherein the text data comprises a query associated with the image data;
processing the input data with a machine-learned model to generate first planning data, wherein the first planning data is descriptive of instructions to provide the image data to a first data processing tool;
providing the image data to the first data processing tool;
receiving first output data from the first data processing tool based on the image data;
processing the first output data with the machine-learned model to generate second planning data, wherein the second planning data is descriptive of instructions to provide a particular portion of the image data to a second data processing tool;
providing the particular portion of the image data to the second data processing tool;
receiving second output data from the second data processing tool based on the particular portion of the image data; and
processing the text data and the second output data with the machine-learned model to generate response data, wherein the response data is descriptive of a response to the query.

18. The one or more non-transitory computer-readable media of claim 17,
wherein the query is descriptive of a question associated with a particular object depicted in the image data.

19. The one or more non-transitory computer-readable media of claim 18, wherein the first data processing tool:
detects a plurality of objects depicted in the image data;
generates a plurality of bounding boxes associated with the plurality of objects;
generates a plurality of image segments based on the plurality of bounding boxes;
classifies each of the plurality of objects in the plurality of image segments to generate a plurality of object classifications; and
generates the first output data, wherein the first output data comprises the plurality of image segments and the plurality of object classifications.

20. The one or more non-transitory computer-readable media of claim 19, wherein the second data processing tool comprises an image search engine, wherein the second data processing tool:
processes one or more of the plurality of image segments with the image search engine to determine one or more web resources associated with the one or more of the plurality of image segments, wherein the one or more of the plurality of image segments are selected by the machine-learned model based on the input data and the plurality of object classifications; and
generates the second output data based on the one or more web resources.

21. (canceled)

22. (canceled)

23. (canceled)

24. (canceled)

25. (canceled)

26. (canceled)

27. (canceled)

28. (canceled)

29. (canceled)

30. (canceled)
